(19) United States
(12) Patent Application Publication
(10) Pub. No.: US 2025/0080666 A1
(43) Pub. Date: Mar. 6, 2025

(54) REMOTE CONTROL SYSTEM, IMAGE PROCESSING APPARATUS, AND NON-TRANSITORY COMPUTER-READABLE RECORDING MEDIUM CONTAINING COMPUTER-EXECUTABLE INSTRUCTIONS THEREFOR

(71) Applicant: BROTHER KOGYO KABUSHIKI KAISHA, Nagoya (JP)

(72) Inventor: Tetsuya OKUNO, Nagoya (JP)

(21) Appl. No.: 18/820,720

(22) Filed: Aug. 30, 2024

(30) Foreign Application Priority Data
Aug. 31, 2023 (JP) 2023-141467

(51) Int. Cl. H04N 1/00

(52) U.S. Cl. CPC H04N 1/00411; H04N 1/00387; H04N 1/00424

(57) ABSTRACT

A remote control system includes an image processing apparatus, a server, and a network terminal. A remote control of the image processing apparatus through the server is possible by user operations on the network terminal. The image processing apparatus displays a first display screen, generates first screen data indicating the first display screen, and transmits the first screen data to the server. The server receives the first screen data, and transmit the first screen data to the network terminal. The network terminal receives the first screen data from the server, and displays the first display screen on the network display based on the first screen data.

### REFERENCE TO RELATED APPLICATIONS

This application claims priority from Japanese Patent Application No. 2023-141467 filed on Aug. 31, 2023. The entire content of the priority application is incorporated herein by reference.

### BACKGROUND ART

The present disclosure relates to a remote control system enabling a remote control of an image processing apparatus from a terminal, an image processing apparatus for such a remote control system, and a non-transitory computer-readable recording medium containing computer-executable instructions for such a remote control system.

Conventionally, there is known a configuration in which a local terminal is directly connected to an image processing apparatus equipped with a touch screen, and the touch screen of the image processing apparatus can be remotely controlled by a user through the local terminal.

### SUMMARY

Typically, when a local terminal is connected to an image processing apparatus on an office's internal network, it is necessary to connect the local terminal to the internal network, or to install a particular tool for connecting with the local terminal on the image processing apparatus.

According to aspects of the present disclosure, there is provide a remote control system comprising an image processing apparatus, a server, and at least one network terminal. The image processing apparatus includes an image processing controller and an image processing display. The server includes a server controller. The network terminal includes a network terminal controller and a network terminal display. A remote control of the image processing apparatus by user operations on the network terminal through the server is enabled. The image processing controller is configured to perform a first displaying process of displaying a first display screen on the image processing display, a first generating process of generating first screen data that indicates the first display screen, the first screen data enabling the network terminal display to display the first display screen, and a first transmitting process of transmitting the first screen data generated in the first generating process to the server. The server controller is configured to perform a first receiving process of receiving the first screen data transmitted from the image processing controller in the first transmitting process, and second transmitting the first screen data received in the first receiving to the network terminal. The network terminal controller is configured to perform a second receiving process of receiving the first screen data transmitted from the server controller in the second transmitting, and a second displaying process of displaying the first display screen on the network display based on the first screen data received in the second receiving process.

According to aspects of the present disclosure, there is provide an image processing apparatus, comprising an image processing controller, and an image processing display. A remote control of the image processing apparatus by user operations on a network terminal through a server is enabled. The image processing controller is configured to perform displaying a first display screen on the image processing display, generating first screen data that indicates the first display screen, the first screen data enabling the network terminal display to display the first display screen, transmitting the first screen data to the server, and displaying the first display screen on the network terminal based on the first screen data received from the server, displaying a second display screen instead of the first display screen on the image processing display, the second display screen being a screen changed from the first display screen, generating second screen data that indicates the second display screen when the second display screen is displayed on the image processing display, the second screen data enabling the network terminal display to display the second display screen, and transmitting the second screen data to the server, and displaying the first display screen on the network terminal based on the first screen data received from the server.

According to aspects of the present disclosure, there is provide a non-transitory computer-readable recording medium containing computer-executable instructions to be executed by a controller of a terminal. The computer-executable instructions including a remote control program. The terminal including a terminal display and an arithmetic unit. The terminal is configured to perform remote control of an image processing apparatus by a user operation through the server. The remote control program causes, when executed by the controller, the arithmetic unit to perform receiving first screen data indicating a display screen displayed on an image processing display of the image processing apparatus from the server, the first screen data enabling the terminal display to display the first display screen, displaying the first display screen on the terminal display based on the first screen data, receiving, from the server, a second screen data enabling the terminal display to display a second display screen displayed on the image processing display of the image processing apparatus instead of the first display screen, the second screen data indicating the second display screen changed from the first display screen, and displaying the first display screen on the terminal display instead of the second display screen based on the second screen data.

### BRIEF DESCRIPTION OF DRAWINGS

FIG. 1 is a block diagram showing a configuration in which a printing system and a remote control system are connected.

FIG. 2 is a block diagram showing an example of a configuration of a printer.

FIG. 3 is a block diagram showing an example of a configuration of a server.

FIG. 4 is a block diagram showing an example of a configuration of a NW (network) terminal.

FIG. 5 is a block diagram showing three connection types when a remote control is performed.

FIG. 6 shows an example of an appearance of a touch panel and operation keys of the printer.

FIG. 7 shows an example of a screen displayed on a web browser of the terminal device that replicates a layout of the touch panel and the operation keys of the printer.

FIGS. 8A and 8B show switching of the touch panel from a home screen to an ink setting screen.

FIG. 9 shows an example of a ripple animation when operations are performed on the web browser screen of the terminal itself.

FIG. 10 shows an example of a ripple animation when operations are performed on the web browser screen of another terminal.

FIGS. 11A and 11B are a sequence chart showing an example of a control procedure while an NW terminal of push-type connection form transmits a connection request and then executes a remote control.

FIG. 12 is a sequence chart showing an example of a control procedure when an NW terminal of push-type connection form transmits a disconnection request and terminates the remote control.

FIGS. 13A and 13B are a sequence chart showing an example of a control procedure during which an NW terminal of pull-type connection form transmits a connection request and then executes a remote control.

FIG. 14 is a sequence chart showing an example of a control procedure when an NW terminal of pull-type connection form transmits a disconnection request and terminates the remote control.

FIGS. 15A and 15B are a sequence chart showing an example of a control procedure between a time when an LC (local) terminal in a local-type connection form transmits a connection request and a time when the LC terminal executes a remote control and completes the remote control.

FIGS. 16A and 16B are a sequence chart showing an example of a control procedure when two NW terminals of the same pull-type connection form remotely operate the same printer simultaneously.

FIG. 17 is a sequence chart showing an example of a control procedure for exclusive execution when an LC terminal in the local connection form requests a connection during remote control by an NW terminal of the pull-type connection form.

FIG. 18 is a sequence chart showing an example of a control procedure when an NW terminal of push-type connection form performs up to a calculation process of time intervals in a long-press operation.

### DESCRIPTION

Hereinafter, an embodiment according to the present disclosure will be described by reference to the accompanying drawings.

### Overview of Network Connection Configuration in Remote Control System

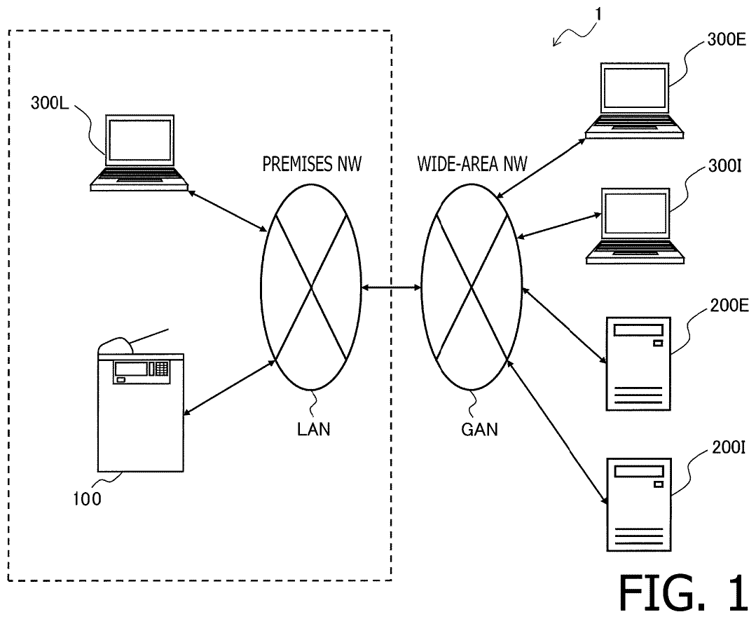

As shown in FIG. 1, the remote control system includes a printer 100 and an LC (local) terminal 300L that are connected to a premises network LAN such as a local area network in a particular site, e.g., in an office or factory, and a server 200E, a server 200I, and NW (network) terminals 300E and 300I that are connected to a wide-area network GAN such as the Internet that covers a wide geographical area. The premises network LAN can communicate with the wide-area network GAN. Concretely, the printer 100 subject to be controlled and the LC terminal 300L are connected in the premises network LAN, while the servers 200E, 200I, the NW terminals 300E and 300I which are managed as part of the remote control system 1 are connected to the wide-area network GAN.

The premises network LAN and the wide-area network GAN are mutually connected via a firewall server (not shown in the figure) so that information can be transmitted and received with each other with information security within the premises network LAN being ensured. In the remote control system 1, the user can directly operate the printer 100, and perform task processes maintenance work on the printer 100 through remote control via the premises network LAN and the wide-area network GAN. The printer 100 may be an image processing office machine having a printing function, a communication function, or an optical reading function, such as a copier, a facsimile machine, a scanner, or an MFP (multi-function peripheral) having some or all of such functions. The printer 100 is an example of an image processing apparatus, the server 200I and the server 200E are examples of a server, and the NW terminal 300I and the NW terminal 300E are examples of a NW terminal.

### Printer

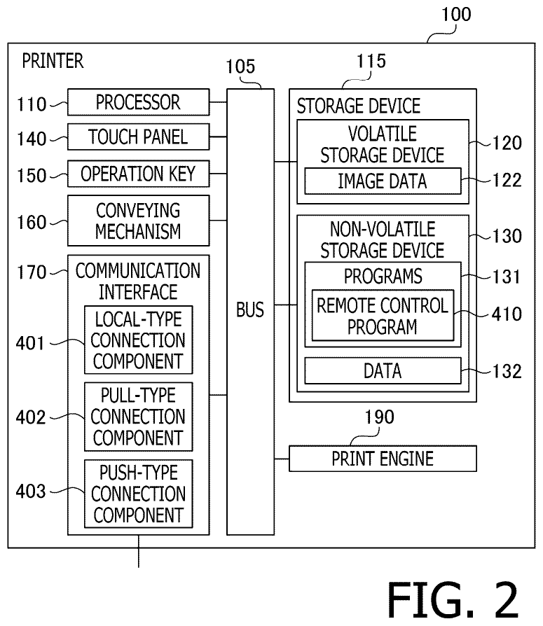

As shown in FIG. 2, the printer 100 has a processor 110, a storage device 115, a touch panel 140, operation keys 150, a conveying mechanism 160, a communication interface 170 and a print engine 190. The processor 110, the storage device 115, the touch panel 140, the operation keys 150, the conveying mechanism 160, the communication interface 170, and the print engine 190 are connected to each other via a bus 105 so that data can be transmitted/received therebetween.

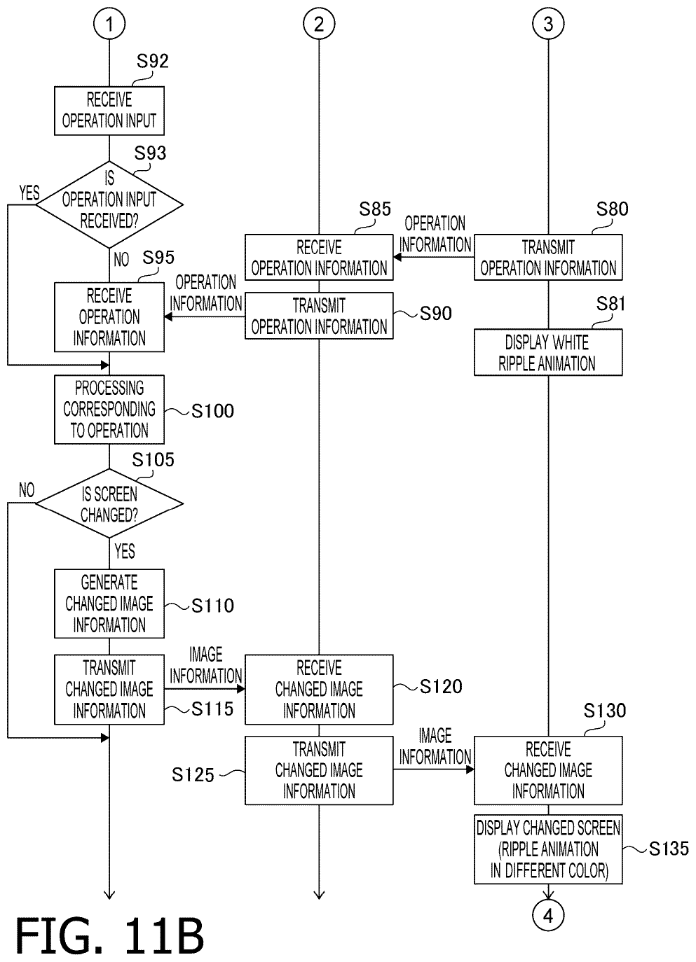

The storage device 115 includes a volatile storage device 120 and a non-volatile storage device 130. The volatile storage device 120 is provided with an image data storage area 122 for storing image data representing an image subject to be printed. The volatile storage device 120 is, for example, a DRAM. The non-volatile storage device 130 is provided with a program storage area 131 and a data storage area 132. The non-volatile storage device 130 is, for example, an NVRAM, a flash memory or the like. Various programs are stored in the program storage area 131. The programs stored in the program storage area 131 include a remote control program 410 corresponding to sequence charts shown in FIGS. 11-18 (described later), firmware such as a print processing program and the like. The data storage area 132 stores various pieces of data which are generated when the various programs described above are executed.

The processor 110 is hardware configured to perform data processing. The processor 110 is, for example, a CPU. The processor 110 is configured to execute the programs stored in the program storage area 131.

The touch panel 140 is configured to display various pieces of information, and is also configured to receive user operations with respect to coordinates on its display screen. The touch panel 140 is a device integrally combining, for example, a liquid crystal display and a transmissive touchpad. The operation keys 150 are devices that mechanically receives user's pressing operations of the operation keys. The communication interface 170 is a network interface that is connected to the premises network to transmit or receive information. The communication interface 170 includes a local-type connection component 401, a pull-type connection component 402, and a push-type connection component 403. The local-type connection component 401, the pull-type connection component 402, and the push-type connection component 403 are modules for transmitting or receiving information to or from the server 200 when remote control is performed, as will be described later.

The conveying mechanism 160 conveys sheets supplied from a tray on which a plurality of sheets can be placed. The print engine 190 is provided in a sheet conveying path by the conveying mechanism 160, and forms images corresponding to a print job on a sheet conveyed by the conveying mechanism 160 using a particular image forming method. The particular method is not limited to a specific one, but can be, for example, an inkjet or laser method. The print engine 190 is configured to perform printing in response to a print job transmitted from the NW terminal 300I, 300E or the LC terminal 300L via the premises network LAN or the wide-area network GAN, or, a print job generated by the printer itself based on operations using the touch panel 140 and the operation keys 150.

The storage device 115 is not necessarily limited to the configuration of the device configuration described above, but may be configured by a combination of, for example, a RAM, a ROM, an EEPROM, a HDD, a portable recording medium such as a USB memory that is detachably attached to the printer 100, a buffer provided by the processor 110, or a combination of these.

The storage device 115 may be a computer-readable storage medium. The computer-readable storage medium is a non-transitory medium. The non-transitory medium includes, in addition to the above examples, recording media such as a CD-ROM, a DVD, and a DVD-ROM, etc. Furthermore, a non-transitory medium is also a tangible medium. The same applies to a storage device 215 of the server 200, which will be described later.

The processor 110 is an example of an image processing controller, and the touch panel 140 is an example of an image processing display and a touch screen.

### Server

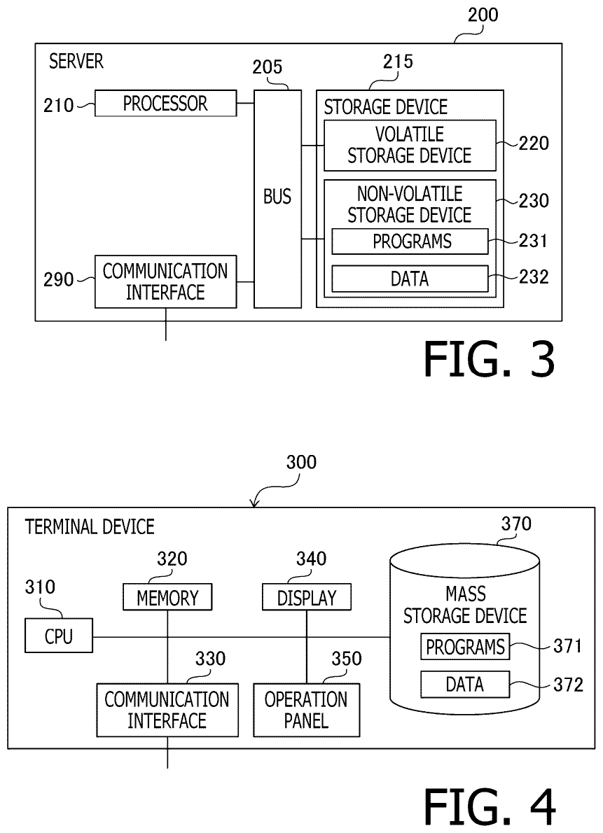

The server 200I and the server 200E both have almost the same configuration as a server 200 with a communication function to transmit and receive data, and an information processing function to process data. A configuration of the server 200 is shown in FIG. 3 as a common configuration of the two servers 200I and 200E. As shown in FIG. 3, the server 200 has a processor 210, a storage device 215, and a communication interface 290. The processor 210, the storage device 215, and the communication interface 290 are interconnected via a bus 205 so that they can transmit and receive data to and from each other.

The storage device 215 has a volatile storage device 220 and a non-volatile storage device 230. The volatile storage device 220 is, for example, a DRAM, which stores various programs and data to be processed. The non-volatile storage device 230 is, for example, a hard disk drive or a solid state drive, and has a program storage area 231 and a data storage area 232. Various programs are stored in the program storage area 231. The various programs include processing programs corresponding to sequence charts, etc., shown in FIG. 11A through FIG. 18 which will be described later. The data storage area 232 stores various data generated during execution of the above processing programs.

The processor 210 is a data processing device, e.g., a CPU, which is configured to execute various programs stored in the program storage area 231. The processor 210 performs various processes including data communication to the printer 100, the NW terminal 300 and the LC terminal 300 that are connected to each of the networks LAN and GAN. It should be noted that the processor 210 is an example of a server controller and the storage device 215 is an example of a server storage.

A communication interface 290 is a network interface configured to transmit and receive information by connecting to the premises network LAN or the wide-area network GAN.

### Terminal Device

The NW terminal 300E that connects to the server 200E, the NW terminal 300I and the LC terminal 300L that connect to the server 200I mentioned above are all equipped with image information display functions, operation input functions, communication functions for transmitting and receiving data, and information processing functions for processing data, and are all configured with a general-purpose personal computer, for example. The configuration common to all of the NW terminal 300E, the NW terminal 300I and the LC terminal 300L is shown in FIG. 4 as the configuration of a terminal 300.

As shown in FIG. 4, the terminal 300 has a CPU 310, a memory 320, a communication interface 330 for connecting to the respective networks, a display 340, an operation panel 350, and a mass storage device 370.

The mass storage device 370 has a program storage area 371 and a data storage area 372. The mass storage device 370 is, for example, a hard disk or flash memory. In the program storage area 371, various programs are stored, for example, as firmware. The various programs include processing programs corresponding to the sequence charts, etc., shown in FIG. 11A through FIG. 18, which will be described later. The CPU 310 executes various programs stored in the program storage area 371. The CPU 310 executes various processes including data communication to the server 200 and printer 100 connected to each of the networks LAN and GAN via the communication interface 330.

The terminal 300 is configured to display various types of information on a display 340, which includes, for example, a liquid crystal display, and to receive various types of operations from the user via an operation panel 350, which includes a pointing device, such as a mouse, and a keyboard.

The terminal 300 may be another information terminal, such as a tablet computer or a smartphone, for example, instead of the general-use personal computer described above. It is noted that the CPU 310 is an example of a network terminal controller, a local terminal controller, and an arithmetic unit, the memory 320 is an example of a terminal storage, and the display 340 is an example of a network terminal display and a local terminal display.

The processor 210 of the printer 100 is configured such that when a user standing in the vicinity of the printer 100 operates the touch panel 140 or the operation keys 150 of the printer 100, the printer 100 performs a particular process corresponding to the user operation. In addition, the processor 210 enables remote control, in which the processor 210 receives operations at other users' NW terminals 300I, 300E or LC terminal 300L, which are physically located remote from the printer 100, via the network and executes processing in response to the received operations. That is, the program that executes processing based on the output of various information and input operations in the printer 100 includes the remote control program 410 that enables remote control of the printer 100 from outside the printer 100.

### Configuration of Remote Control Process

The printer 100 is configured to transmit and receive information using a communication protocol appropriate to a connection configuration with the terminal 300. Concretely, the processor 210 of the printer 100 communicates individually via a local-type connection component 401, a pull-type connection component 402, and a push-type connection component 403 based on the remote control program 410.

Hereinafter, the connection configuration between the terminal and the printer 100 in the remote control process performed by the remote control system according to the embodiment will be described.

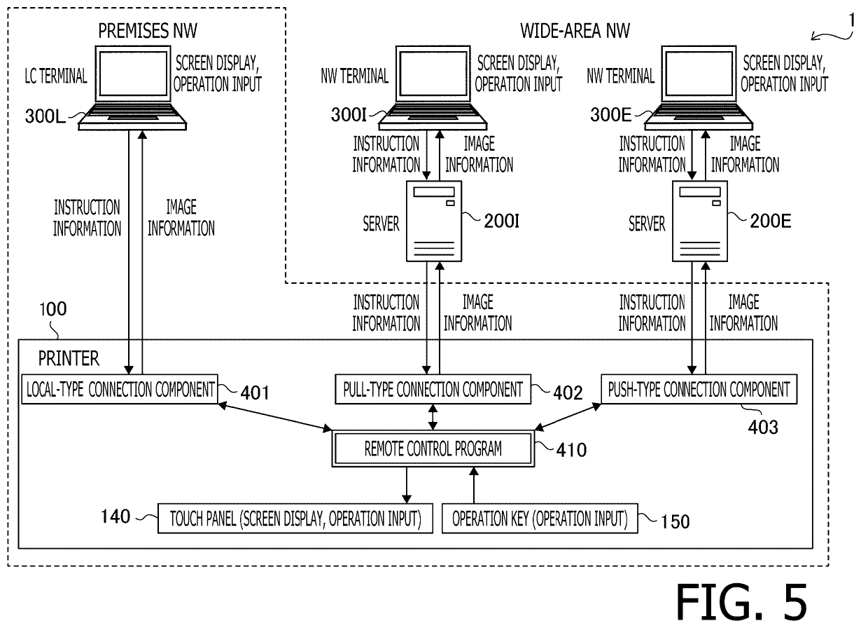

The center of FIG. 5 shows a configuration of the remote control system 1 performs the remote control processing, as a pull-type connection configuration, in which the NW terminal 300I is indirectly connected to the printer 100 via the server 200I. In the pull-type configuration, the printer 100 is connected to the server 200I via the pull-type connection component 402. The printer 100 perform polling to the server 200I via the pull-type connection component 402 based on the HTTPS protocol to transmit and receive information.

The right side of FIG. 5 shows a configuration of the remote control system 1 performs the remote control processing, as a push-type connection configuration, in which the NW terminal 300E is indirectly connected to the printer 100 via the server 200E. In the push-type connection configuration, the printer 100 is connected to the server 200E via the push-type connection component 403. The server 200E transmits commands directly to the printer 100 via the push-type connection component 403 based on the MQTT protocol or XMPP. In the push-type connection configuration, the printer 100 in the on-premises NW is always connected to the server 200E in the off-premises NW using the above protocol, thereby making it possible to issue instructions in real time from the off-premises NW.

As a reference, the left side of FIG. 5 shows a configuration of the remote control system 1 performs the remote control processing, as a local type connection configuration, in which the LC terminal 300L is connected to the printer 100 via the local-type connection component 401.

This type of remote control system 1 has an advantage of being able to perform particular tasks and operations at a location remote from the printer 100.

In particular, in the remote control system 1 based on the push-type connection configuration, the NW terminal 300E in the wide-area network GAN is indirectly connected to the printer 100 in the premises network LW via the server 200E also in the wide-area network GAN. In such a case, the printer 100 does not need to use any special configuration or tools to connect to the server 200E, which is located outside the premises network LW, as it can be accessed over the Internet using a URL. Further, the NW terminal 300E in the wide-area network GAN can also normally access the server 200E using the URL as well.

According to the remote control system 1, it is possible to display the same screen display contents on the NW terminal 340 as the screen display contents on the touch panel 140, which is the display of the printer 100, using the above configuration. Further, it is also possible to input operations using the operation panel 350 of each terminal 300 as well as the touch panel 140 of the printer 100 or the operation keys 150.

Further, in the pull-type connection configuration, the printer 100 polls the server 200I via the pull-type connection component 402 based on the HTTPS protocol to transmit and receive information. Accordingly, the processor 210 of the printer 100 transmits the changed image information to each terminal 300 only when the screen display has changed significantly in response to various operational inputs. In this way, the screen necessary for performing the remote control can be displayed, while communication traffic can be greatly reduced, enabling smooth remote control by the user and improving convenience.

The polling of the printer 100 in the pull-type connection configuration will be described. First, the operation information corresponding to the operation on the NW terminal 300I is stored in the storage device 215 of the server 200I. The printer 100 is configured to query the server 200I for existence of the operating information through software interrupts at particular time intervals, such as a machine cycle of the printer 100 or at five-second intervals, for example. At the time of the query, the server 200I transmits the stored operation information to the printer 100, where the information is retrieved by the printer 100. In this way, the communication load between the printer 100 and the server 200 can be kept to the minimum necessary because the printer 100 can obtain the operation information from the server 200 by the so-called polling technique. It is noted that the process of causing the server 200I to store the operation information in the storage device 215 is an example of a first event storing process, the machine cycle of the printer 100 is an example of first particular intervals, and the process in which the printer 100 actively queries the server 200I for the existence of operation information in the machine cycle of the printer 100 is an example of a first event query transmitting process.

In the present embodiment, it is assumed that at the start of the remote control, a web program written in XML, for example, is transmitted from the printer 100, and the terminal 300 receives the web program and executes it on a web browser, i.e., a so-called web application is adopted. However, it may also be in the form of a so-called desktop application that is independently launched on the OS of the terminal 300.

### Concrete Screen Display Contents When Remote Control is Performed

In the following, the screen display contents on each of the touch panel 140 of the printer 100 and the display 340 of each NW terminal during the above remote control will be described.

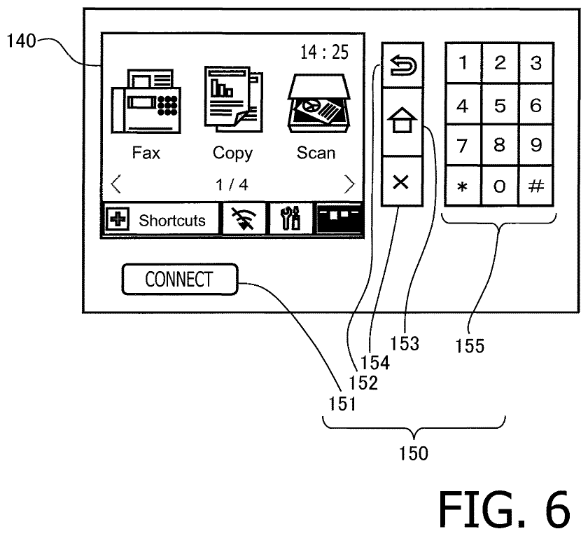

FIG. 6 shows an example of an appearance of the touch panel 140 and the operation keys 150, which are provided together in the console of the actual printer 100. In the example shown in FIG. 6, multiple operation keys 150 are arranged around the vicinity of a rectangular-shaped touch panel 140. The multiple operation keys 150 includes connection key 151 located at the lower side of the touch panel 140 and a return key 152, a home key 153, a cancel key 154, and a numeric keypad 155 are located at the right side of the touch panel 140. A user standing near the actual printer 100 can refer to various information such as messages and parameters displayed on the touch panel 140 and press and operate various icons and specific operation keys 150 displayed on the same touch panel 140 to make the printer 100 perform the desired process.

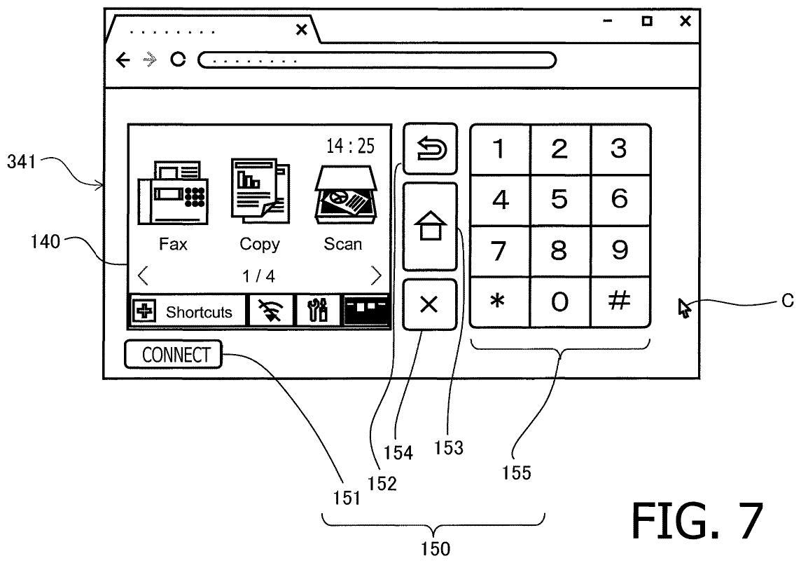

As shown in FIG. 7, the display 340 of each terminal 300 that performs remote control has a screen configuration that imitates the arrangement of the touch panel 140 and the operation keys 150 of the printer 100 shown in FIG. 6. The display 340 is displayed on a so-called GUI (Graphical User Interface) of the web browser screen 341 of the terminal 300. The user using the terminal 300 can refer to various information such as messages and parameters displayed on the touch panel 140, and can operate various icons and icons of the virtual operation keys 150 by manipulating the cursor C in a web browser screen 341 using a pointing device such as a mouse (not shown). In this way, the user of each terminal 300 can remotely control the printer 100 with a sense of operation equivalent to operating the printer 100 directly.

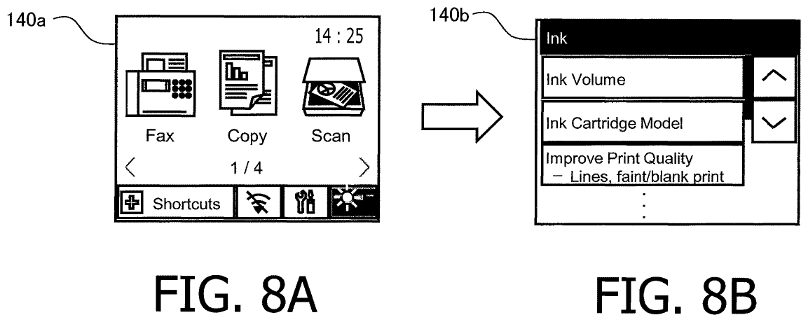

In a state where the printer 100 and the terminal 300 are connected via the server 200, a home screen 140a of the touch panel 140 of the printer 100 is displayed as shown in FIG. 8A. When the user presses an INK icon at the lower-right corner of the touch panel 140a, a menu process is performed to switch the display to the ink setting screen 140b shown in FIG. 8B. In response to the above, when the INK icon on the home screen 140a is pressed on the web browser screen 341 of the terminal 300, the instruction information including the content of the operation event and the coordinate of the pressed position is transmitted to the printer 100, and only the image information of the ink setting screen 140b is received immediately as a reply to the pressing operation. In this way, the user can quickly switch screen displays in response to operation input on the terminal 300, and can remotely control the printer 100 with display content synchronized in approximately real time with the touch panel 140 of the printer 100, as when the user is operating the printer 100 directly.

The display content on the web browser screen 341 of the terminal 300 is a content where the display content of the LCD screen of touch panel 140 and the screen on which the icons of the multiple operation keys 150 are otherwise arranged are combined. The display content of the LCD screen changes significantly according to the operation input and processing content, while on the other hand, the display content of the icon screen of multiple operation keys 150 can be generated by combining images that have been prepared in advance. Therefore, at least when the printer 100 generates the image information of the LCD screen and transmits the image information via the server 200 to be displayed on the terminal 300, any of the printer 100, server 200, and terminal 300 can store the image information of the icon screen of the operation keys 150 and combine the same with the image information of the LCD screen. In the present embodiment, the terminal 300 stores the image information of the icon screen of the operation keys 150, and the image information of the icon screen of the operation keys 150 is combined with the received image information of the LCD screen and displayed on the web browser screen 341. In this way, it is possible to reduce the data quantity of the image information to be distributed in the wide-area network GAN between the printer 100, the server 200, and the terminal 300, thereby reducing traffic delays.

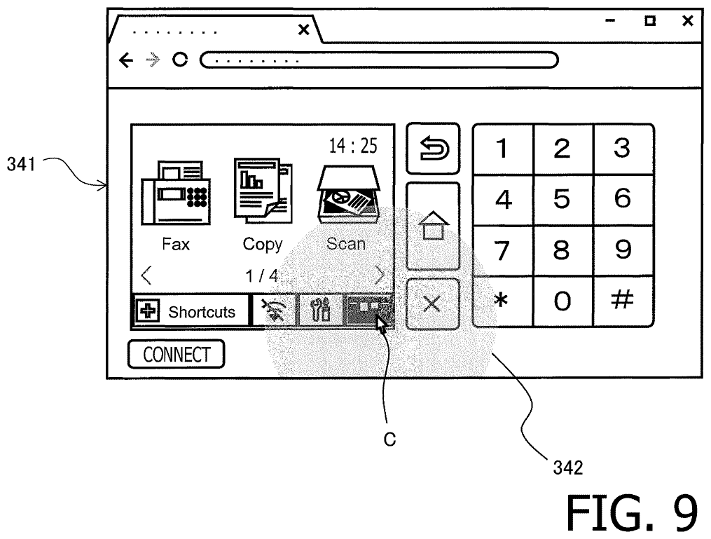

It is preferable that the pressing operation performed by the user is visually indicated for which icon or which position in the screen coordinates on the web browser screen 341 of the terminal 300 or on the touch panel 140 of the printer 100. In the present embodiment, when the user performs a pressing operation with the cursor C on the web browser screen 341, an animation 342 of ripples centered on the pressing operation position that spreads and disappears in a short time is displayed, as shown in FIG. 9. Although not specifically shown in the figures, the printer 100 may also display a similar ripple animation on the touch panel 140 of the printer 100 when the user performs a pressing operation on the touch panel 140 of the printer 100.

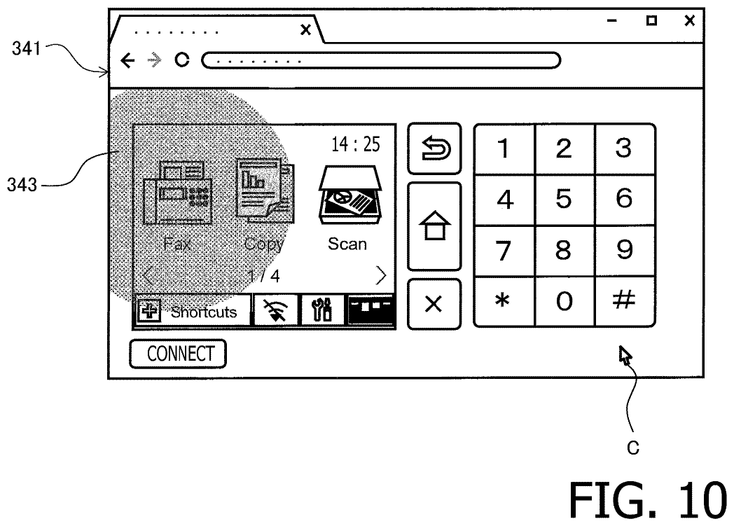

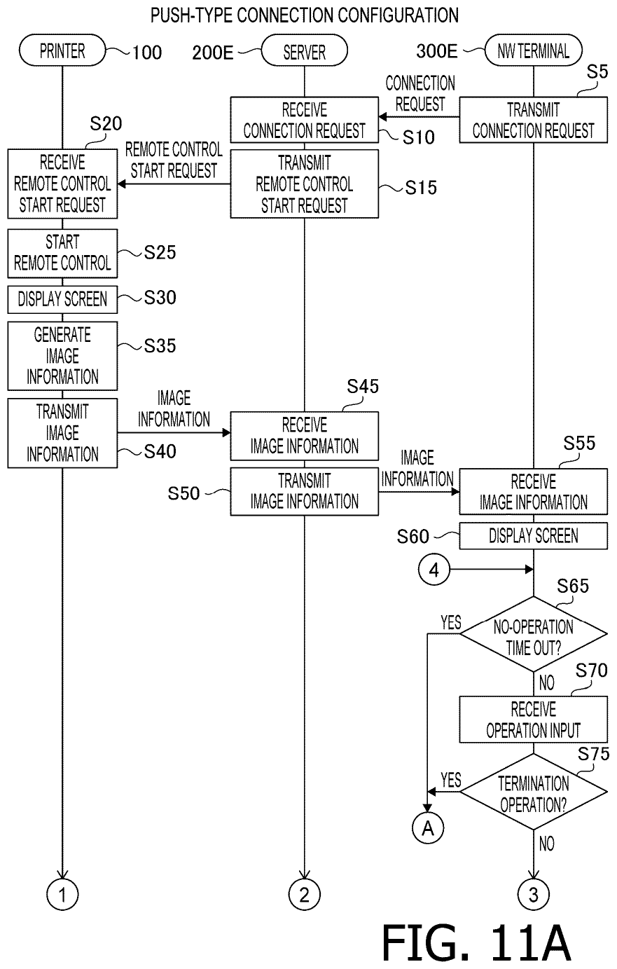

When multiple users operating the printer 100 and the terminal 300, respectively, are accessing the printer 100 simultaneously, it is preferable that the display content of the same touch panel 140 can be shared in real time while clearly indicating which user performs which operation. Accordingly, in the present embodiment, when a user of another terminal other than the own terminal performs a pressing operation, an animation 343 of ripples centered on the position of the pressing operation (a different position from the own cursor C) is displayed in a distinguished color corresponding to the user, as shown in FIG. 10. For example, the operation by the user's own terminal is displayed in white, while the operation by the user of the printer 100 and/or other terminals are displayed in different colors other than white, making it easy to visually distinguish who performed which operation.

In the above case, when the terminal 300 receives the image information reflecting the operation by the user of the printer 100 or the user of the other terminal 300, the coordinate position information of the pressing operation on the LCD screen of the touch panel 140 or the pressed key information indicating which operation key 150 is pressed is also transmitted and received together with the image information. In this way, the terminal 300 can display the ripple animation 343 based on the operation of the user of the printer 100 or the user of the other terminal at an appropriate position centered on the coordinate position in the LCD screen or the position of the pressed key. It should be noted that this coordinate position information and pressed key information is an example of touch event information.

Change conditions, which are for the printer 100 to transmit the image information to the terminal 300 to change the screen display, do not include auxiliary screen display changes such as the switching of the clock display on the screen or changes in the amount of ink remaining over time. The printer 100 should be configured to transmit new image information to change the screen display only when an operation performed by one of the users causes a substantial change in the operation screen display.

### Control Procedure of Push-Type Connection Configuration

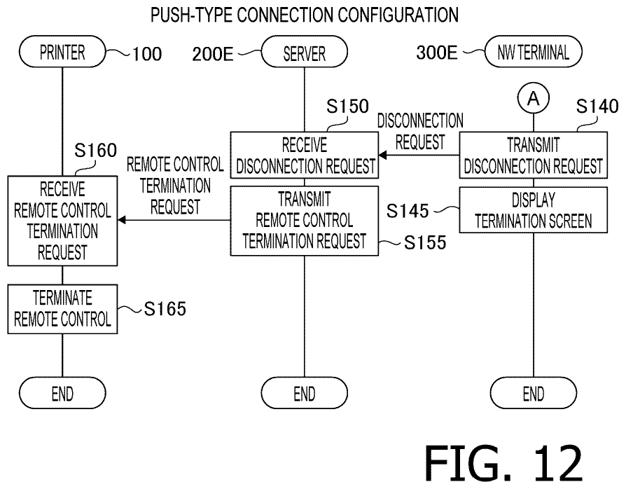

In order to realize the above remote control processing in the push-type connection configuration according to the present embodiment, an example of the control procedure executed by the processor 110 of the printer 100, the processor 210 of the server 200E, and the CPU 310 of the NW terminal 300E is described referring to the sequence charts in FIGS. 11A, 11B and 12. FIGS. 11A and 11B show a control procedure during the execution of remote control after the NW terminal 300E transmits a connection request, and FIG. 12 shows procedure when the NW terminal 300E terminates remote control due to a no-operation timeout or by transmitting a particular disconnection request. It is assumed that, prior to the start of this sequence, the printer 100 has established a mutually accessible state with the server 200E via a general Internet connection using a URL.

First, in S5, the user presses the connection key 151 on the web browser screen 341 at the NW terminal 300E, which causes the NW terminal 300E to transmit a connection request to the server 200E to start a remote control of the printer 100. After receiving this connection request in S10, the server 200E transmits a remote control start request to the printer 100 in S15. After receiving the remote control start request in S20, the printer 100 performs various processes in S25 to become ready to accept remote control from the NW terminal 300E.

Next, the printer 100 displays a screen on the touch panel 140 based on its current status in S30, generates image information corresponding to that screen in S35, and then transmits the image information to the server 200E in S40. It is preferable that the image information transmitted by the printer 100 is, for example, image data in the so-called BMP format, in which the bitmap information of a bitmap display is converted directly into data without encoding. However, when priority is given to reducing communication traffic, the image data may be transmitted in the so-called JPG or PNG formats, which are encoded to save quantity.

After receiving the image information in S45, the server 200E transmits the image information to the NW terminal 300E in S50. After receiving the image information in S55, the NW terminal 300E displays a screen based on the received image information on the display 340 in S60. This starts the remote control of the printer 100 from the NW terminal 300E.

Thereafter, the NW terminal 300E determines whether a no-operation timeout has occurred in S65. Concretely, the NW terminal 300E determines whether a particular period of time has passed without any operation input from the user of the NW terminal 300E since the most recent operation input received from the user of the NW terminal 300E in the past. When the no-operation timeout has occurred (S65: YES), and the program moves to S140 shown in FIG. 12. On the other hand, when some operation input is received from the user before the particular period of time has passed (S65: NO), the no-operation timeout has not occurred and the NW terminal 300E receives the operation input in S70. In S75, the NW terminal 300E determines whether the received operation input is an operation to terminate the remote control. When the received operation input is the termination operation (S75: YES), the process moves to S140 of FIG. 12. On the other hand, when the received operation input is not the termination operation (S75: NO), the NW terminal 300E transmits the operation information to the server 200E in S80.

Thereafter, when the operation input is a pressing operation in S81, the NW terminal 300E displays an animation 342 in which a white ripple is enlarged to a particular size and disappears centered on the pressed position of the cursor C (see FIG. 9). Thereafter, the NW terminal 300E does not receive any operation input until the changed image information is received in S130. In this way, it is possible to stabilize operability by ignoring unnecessary continuous operation input from the user. It is noted that the NW terminal 300E may be configured to receive operation input by the user while the animation 342 is being displayed in S81 and until the changed image information is received in S130.

After receiving the operation information in S85, the server 200E transmits the operation information to the printer 100 in S90. After receiving the operation information in S95, the printer 100 performs processing corresponding to the received operation information in S100. It is noted that the printer 100 also receives the operation input from the user via the touch panel 140 and/or operation key 150 in S92 and S93 before receiving the operation information from the server 200E in S95. When the printer 100 determines that some operation has been input to the touch panel 140 and/or the operation key 150, the printer 100 performs a processing corresponding to the operation input (i.e., hereafter referred to as an operation response process) in S100. It is noted that the operation response process includes not only processing corresponding to the operation input, but also displaying a corresponding new changed screen and/or generating of touch event information.

Then, in S105, the printer 100 determines whether there has been a substantial change in the screen display due to the previous operation response process. When there is a substantial screen change due to the operation input (S105: YES), the printer 100 generates image information of the changed screen reflecting the change in S110, and transmits the changed image information to the server 200E in S115. On the other hand, when the screen changes are only auxiliary changes due to the clock display, remaining ink level, or the like, and there is no substantial change in the operation screen due to operation input (S105: NO), S110 and S115 are omitted.

When the screen change is not caused by an operation input from the NW terminal 300E to which the changed image information is returned, the printer 100 generates the changed image information in S110, which includes the ID of the device that causes the screen change and the coordinate information of the pressing operation, and transmits the same to the server 200E.

After receiving the changed image information in S120, the server 200E transmits the changed image information to the NW terminal 300E in S125. After receiving the changed image information in S130, the NW terminal 300E displays a changed screen reflecting the changed information on the display 340 in S135. In this way, the screen with the content changed in response to the operation panel entered via the NW terminal 300E is also reflected and displayed on the display 340 of the NW terminal 300E. Then, the NW terminal 300E returns to S65 and repeats the same procedure.

When, in S135, the changed image information includes the coordinate information of the pressing operation and the ID of the device that performs the operation, the NW terminal 300E displays an animation 343 of the expansion and disappearance of the ripple centered on the coordinate position in the color corresponding to the ID, on the display 340.

On the other hand, when the NW terminal 300E determines that the remote control is to be terminated in S65 and S75, the NW terminal 300E transmits a disconnection request to the server 200E in S140 in FIG. 12, and then, in S145, displays on the display 340 the termination screen showing that the remote control has been terminated.

After receiving the disconnection request in S150, the server 200E transmits a remote control termination request to the printer 100 in S155. After receiving the remote control termination request in S160, the printer 100 performs various processes for terminating the remote control as necessary and terminates the remote control in S165.

### Control Procedure of Pull-Type Connection Configuration

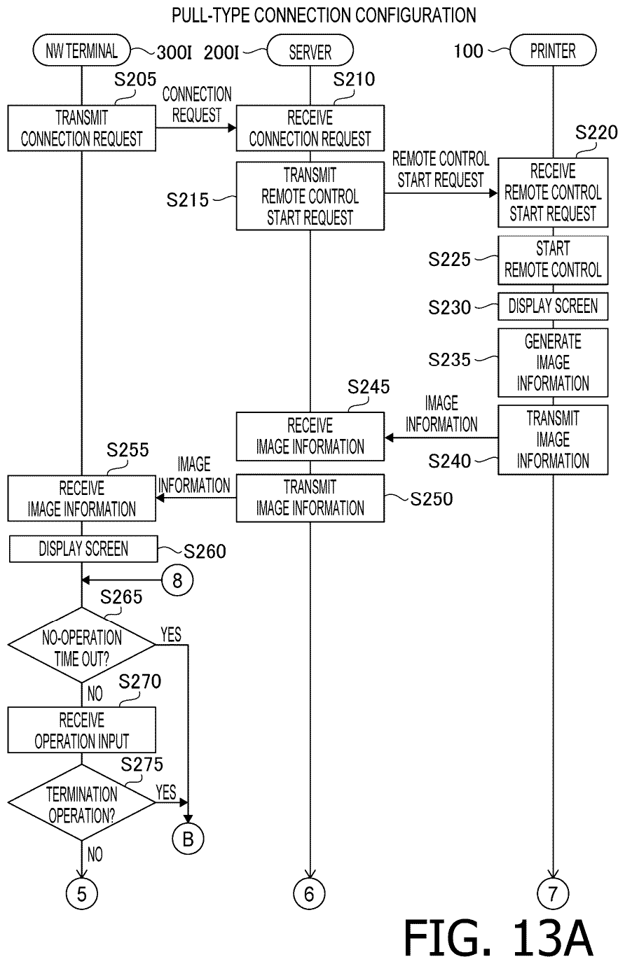

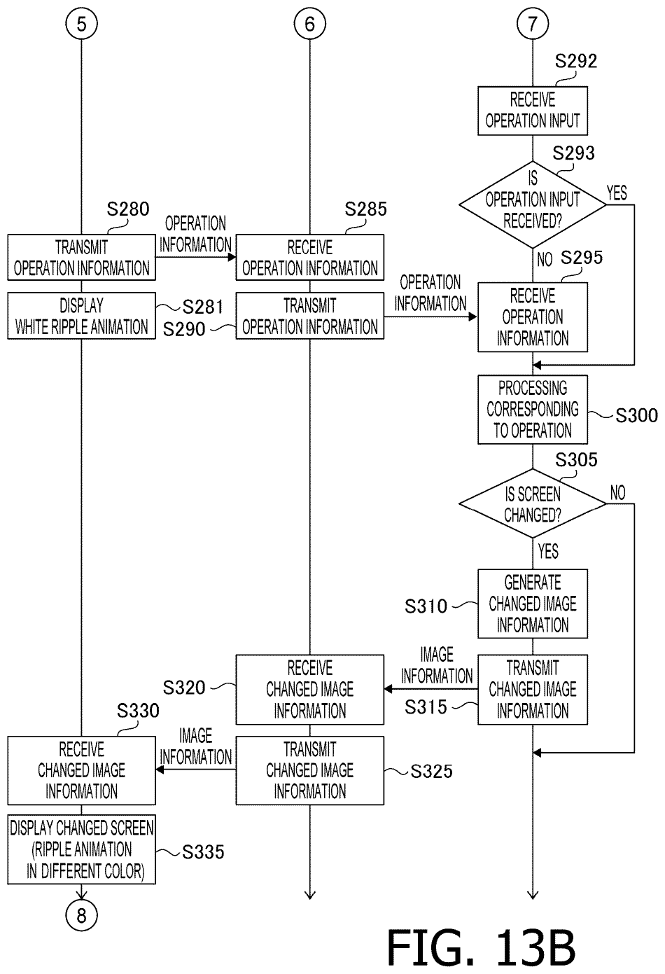

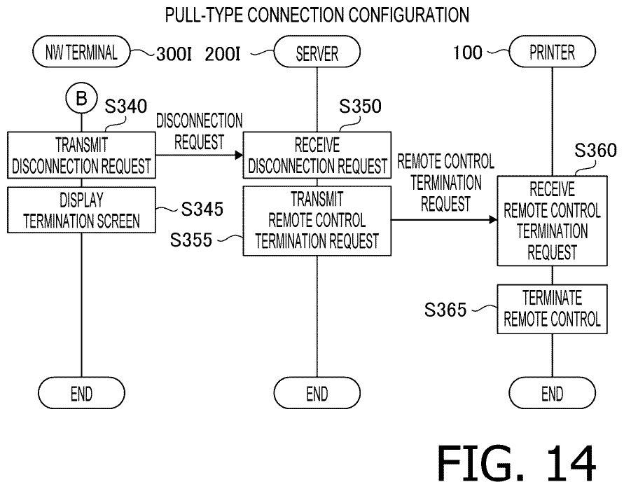

An example of the control procedure performed by the processor 110 of the printer 100, the processor 210 of the server 200I, and the CPU 310 of the NW terminal 300I to achieve remote control processing in a pull-type connection configuration is described with reference to sequence charts shown in FIGS. 13A, 13B and FIG. 14. FIGS. 13A and 13B is a control procedure during the execution of remote control after the NW terminal 300I transmits the connection request, and FIG. 14 is a control procedure when the NW terminal 300I terminates remote control by transmitting a no-operation timeout or a particular disconnection request.

First, in S205, when the user presses the connection key 151 on the web browser screen 341 of the NW terminal 300I, the NW terminal 300I transmits a connection request to the server 200I to start the remote control over the printer 100. After receiving the connection request in S210, the server 200I transmits a remote start request to the printer 100 in S215. More concretely, the printer 100 transmits a query to the server 200I at particular time intervals by polling, and the server 200I transmits a remote start request to the printer 100 in response to receipt of the query from the printer 100. After receiving this remote control start request in S220, the printer 100 executes various processes in S225 to become ready to accept the remote control from the NW terminal 300I.

Then, the printer 100 displays a screen on the touch panel 140 based on the current status in S230, generates the image information corresponding to that screen in S235, and then transmits the image information to the server 200I in S240. After receiving the image information in S245, the server 200I transmits the image information to the NW terminal 300I in S250, and the NW terminal 300I receives the image information in S255. In the pull-type connection configuration, the NW terminal 300I obtains image information from the server 200I by polling. Concretely, although not shown in the figure, the server 200I stores the received image information in the storage device 215 in S245 above, and the NW terminal 300I actively queries the server 200I at particular time intervals, for example, every 5 seconds, to check whether the image information is available. In response to the query, if the server 200I stores the image information, the server 200I transmits the image information in S250, and the NW terminal 300I receives the image information from the server 200I in S255. After receiving the image information in S255, the NW terminal 300I displays a screen based on that image information on the display 340 in S260. In this way, the remote control of the printer 100 is initiated from the NW terminal 300I.

Thereafter, the NW terminal 300I determines whether a no-operation timeout has occurred in S265. Concretely, the NW terminal 300I determines whether a particular period of time has passed without any operation input from the user of the NW terminal 300I since the most recent operation input received from the user of the NW terminal 300I in the past. When the no-operation timeout occurs (S265: YES), and the process moves to S340 shown in FIG. 14. On the other hand, when some operation input has been received from the user before the elapsed time for no-operation timeout is reached (S265: NO), and the NW terminal 300I accepts that operation input in S270. In the next step S275, the NW terminal 300I determines whether the accepted operation input is an operation to terminate the remote control. When the received operation input is a termination operation (S275: YES), and the process moves to S340 in FIG. 14. On the other hand, if the accepted operation input is not a termination operation (S275: NO), and the NW terminal 300I transmits the operation information to the server 200I in S280.

Thereafter, the NW terminal 300I displays an animation 342 in which a white ripple is enlarged to a particular size centered on the pressed position of the cursor C and disappears when the cursor C is pressed on the display 340 in S281 (see FIG. 9). After that, no further operation input is received until the changed image information is received in S330, which will be described later.

After receiving the operation information in S285, the server 200I transmits the operation information to the printer 100 in S290. More concretely, the printer 100 transmits a query to the server 200I at particular time intervals by polling, and the server 200I transmits operation information to the printer 100 upon receipt of the query from the printer 100. After receiving the operation information in S295, the printer 100 executes the process corresponding to that operation information in S300. As described above, in this pull-type connection configuration, the printer 100 obtains operation information from the server 200I by polling. Therefore, although not specifically shown in the figure, the server 200I stores the operation information received in S285 in the storage device 215, and the printer 100 actively queries the server 200I at particular time intervals, for example, every 5 seconds, to check whether the operation information is available. Then, in response to that query, when the server 200I stores the operation information, the operation information is transmitted and received in S290 and S295. It is noted that, in such a case, the process in which the server 200I stores the operation information in the storage device 215 in S285 is an example of a first event storing process. Further, the 5-second interval in the above embodiment is an example of the first particular intervals, and the process in which the printer 100 actively queries the server 200 at the 5-second interval in the above example before S290 is an example of the first event query transmitting process.

When the printer 100 receives operation input from the user of the printer 100 via the touch panel 140 and/or operation keys 150 in S292 and S293 before receiving the operation information from the server 200I in S295, and determines that some operation input has been received, the printer 100 performs an operation-corresponding process which is a process corresponding to the operation input in S300. It should be noted that the operation-corresponding process includes not only a process corresponding to that operation input, but also a process of the corresponding new screen display and the generation of touch event information.

Thereafter, the printer 100 determines in S305 whether the screen display has been substantially changed by the previous operation-corresponding process. When there is a substantial screen change due to the operation input (S305: YES), and the printer 100 generates, in S310, changed image information, which is the image information of the changed screen reflecting the change, and transmits, in S315, the changed image information to the server 200I. On the other hand, When the screen change is an auxiliary change due to the clock display or remaining ink level, and there is no substantial change due to the operation input (S305: NO), and processes of S310 and S315 are skipped.

Further, when the screen change was not caused by an operation input from the NW terminal 300I to which the changed image information was returned, the printer 100 generates the changed image information in S310 above, including the ID of the device that caused the screen change and the coordinate information of the pressing operation, and transmits the same to the server 200E.

After receiving the changed image information in S320, the server 200I transmits the changed image information to the NW terminal 300I in S325. After receiving the changed image information in S330, the NW terminal 300I displays the changed screen reflecting the changed image information on the display 340 in S335. It should be noted that even when the changed image information is transmitted or received in S325 and S330, the NW terminal 300I obtains the changed image information from the server 200I by polling. In this way, the screen with the content changed in response to the operation entered at the NW terminal 300I is also reflected and displayed on the display 340 of the NW terminal 300I. Then, the NW terminal 300I returns to S265 and repeats the same procedure.

When, in S335, the changed image information includes the coordinate information of the pressing operation and the ID of the device in which the pressing operation was performed, the NW terminal 300I also displays an animation 343 of the expansion and disappearance of the ripple centered on the coordinate position in the color corresponding to that ID on the display 340.

On the other hand, when the remote control is determined to be terminated in S265 and S275, the NW terminal 300I transmits a disconnection request to the server 200I in S340 of FIG. 14, and then displays a termination screen on the display 340 in S345 with the contents indicating that the remote control has been terminated.

After receiving the disconnection request in S350, the server 200I transmits a remote control termination request to the printer 100 in S355. After receiving the remote control termination request in S360, the printer 100 executes various processes for terminating the remote control as necessary and terminates the remote control in S365.

### Control Procedure of Local Connection Configuration

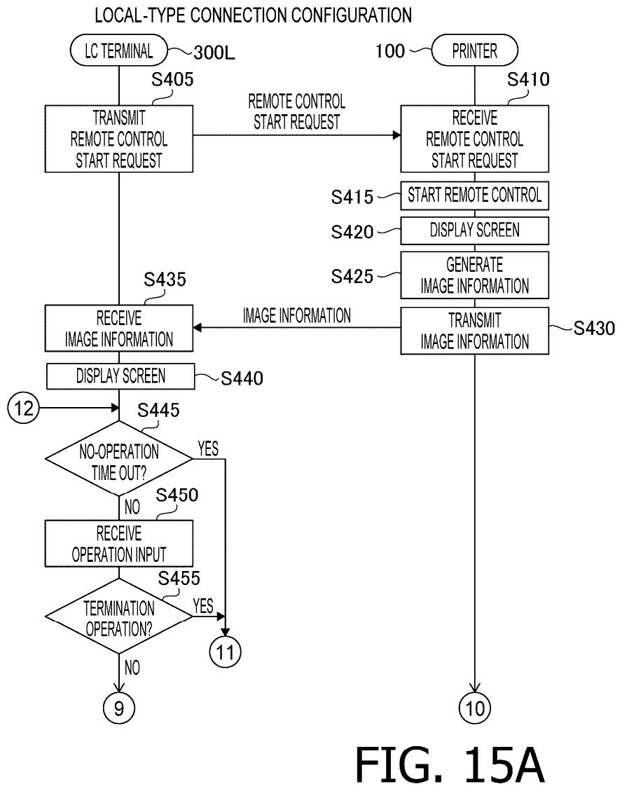

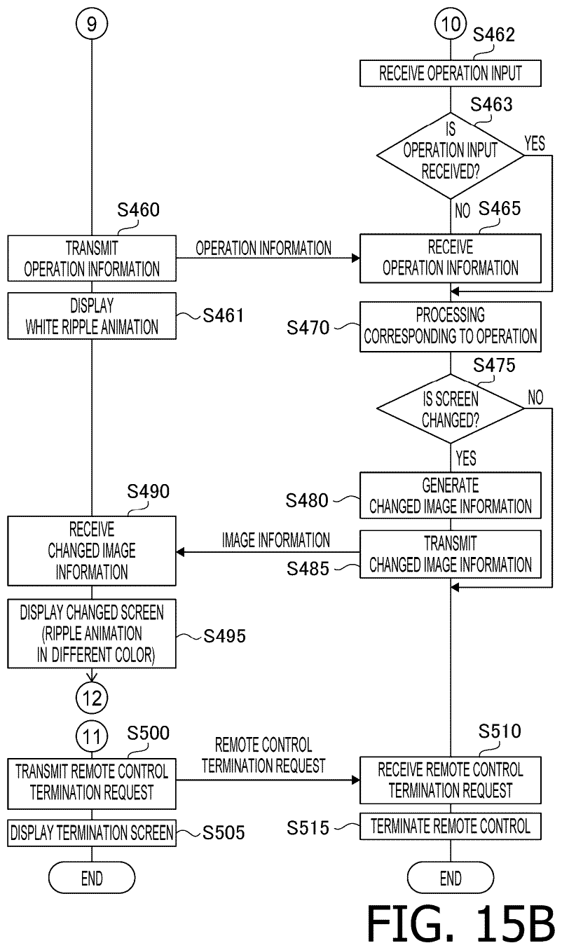

A sequence chart in FIGS. 15A and 15B illustrates an example of a control procedure performed by the processor 110 of the printer 100 and the CPU 310 of the LC terminal 300L to realize the remote control process in the local connection configuration. FIGS. 15A and 15B shows a control procedure from the time the LC terminal 300L transmits a connection request to the termination of remote control by transmitting a no-operation timeout or a particular disconnection request.

In S405, the LC terminal 300L transmits a connection request to the printer 100 to start remote control of the printer 100, as the user presses the connection key 151 on the web browser screen 341 in this example. After receiving the remote control start request in S410, the printer 100 performs various processes for starting the remote control as necessary in S415 to become ready to accept remote control from the LC terminal 300L.

Next, the printer 100 displays a screen on the touch panel 140 based on a state at that point in time in S420, generates image information corresponding to that screen in S425, and then transmits the image information to the LC terminal 300L in S430. After receiving the image information in S435, the LC terminal 300L displays a screen based on the image information on the display 340 in S440. As described above, the remote control of the printer 100 is started from the LC terminal 300L.

Thereafter, the LC terminal 300L determines in S445 whether a no-operation timeout has occurred. Concretely, the LC terminal 300L determines whether a particular period of time has passed without any operation input from the user of the LC terminal 300L since the most recent operation input received from the user of the LC terminal 300L. If the no-operation timeout has occurred (S445: YES), the process moves to S500. On the other hand, if some operation input has been received from the user before an elapsed time for the no-operation timeout is reached (S445: NO), the operation input is accepted in S450. Then, in S455, the LC terminal 300L determines whether the accepted operation input is an operation to terminate the remote control. If the received operation input is a termination operation (S455: YES), the control moves to S500. On the other hand, if the accepted operation input is not the termination operation (S455: NO), the LC terminal 300L transmits the operation information to the printer 100 in S460.

Thereafter, the LC terminal 300L displays an animation 342 in which a white ripple is enlarged to a particular size centered on the pressed position of the cursor C and disappears when the cursor C is pressed on the display 340 in S461 (see FIG. 9). Thereafter, the LC terminal 300L does not accept any operation input until receiving the changed image information in S490 (described later).

After receiving the operation information in S465, the printer 100 performs a process corresponding to the received operation information in S470. It is noted that, if it is determined that the printer 100 receives an operation input from the user of the printer 100 via the touch panel 140 and/or operation keys 150 in S462 and S463 before receiving the operation information from the LC terminal 300L in S465, the printer 100 moves to step S470 and performs a process corresponding to the operation input. It should be noted that the operation-corresponding process also includes a process for displaying a new corresponding screen and/or generating touch event information.

Thereafter, the printer 100 determines in S475 whether there has been a substantial change in the screen display due to the previous operation-corresponding process. If there is a substantial screen change due to the operation input (S475: YES), the printer 100 generates image information of the changed screen reflecting the change in S480 and transmits the changed image information to the LC terminal 300L in S485. On the other hand, if there is only an auxiliary screen change due to the clock display or remaining ink level and no substantial screen change due to operation input (S475: NO), S480 and S485 are skipped.

If the cause of the screen change is not due to an operation input from the LC terminal 300L to which the changed image information is returned, the printer 100 generates the changed image information in S485, including the ID of the device that caused the screen change and the coordinate information of its pressing operation, and transmits the information to the LC terminal 300L.

After receiving the changed image information in S490, the LC terminal 300L displays the changed screen reflecting the changed image information on the display 340 in S495. In this way, the screen with the content changed in response to the operation panel and/or the LC terminal 300L is also reflected and displayed on the display 340 of the LC terminal 300L. Then, the LC terminal 300L returns to S445 and repeats the same procedure.

If, in S495, the changed image information includes the coordinate information of the pressing operation and the ID of the device in which the pressing operation was performed, the LC terminal 300L displays the image on the screen in the color corresponding to the ID, including an animation 343 of the expansion and disappearance of the ripples centered on that coordinate position.

On the other hand, when the LC terminal 300L determines that the remote control is to be terminated in S445 and S455, the LC terminal 300L transmits a disconnection request to the printer 100 in S500, and then displays a termination screen on the display 340 in step S505 with the contents indicating that the remote control has been terminated. After receiving the remote control termination request in S510, the printer 100 performs various processes for terminating the remote control as necessary and terminates the remote control in S515.

The screen displayed in S30 and S230 is an example of a first display screen, and S30 and S230 are examples of a first displaying process. The image information generated in S35 and S235 is an example of first screen data, and S35 and S235 are examples of a first generating process. S40 and S240 are examples of a first transmitting process, and S45 and S245 are examples of a first receiving process. S50 and S250 are examples of a second transmitting process, and S55 and S255 are examples of a second receiving process. S60 and S260 are examples of a second displaying process.

The changed screen is an example of a second display screen, and S100 is an example of a third displaying process. The changed image information is an example of second screen data, and S110 and S310 are examples of a second generating process. S115 and S315 are examples of a third transmitting process, and S120 and S320 are examples of a third receiving process. S125 and S325 are examples of a fourth transmitting process, and S130 and S330 are examples of a fourth receiving process. S135 and S335 are examples of a fourth displaying process.

S70 and S270 are examples of a first operation receiving process. The operation information is an example of touch event information. S80 and S280 are examples of a first event transmitting process, and S85 and S285 are examples of a first event receiving process. S90 and S290 are examples of a second event transmitting process, and S95 and S295 are examples of a second event receiving process.

S105 and S305 are examples of a change identifying process.

A process to disable operation input between S81 and S130 is an example of a disabling process.

S92, S292 and S462 are examples of an instruction receiving process and a machine-operation receiving process. S100, S300 and S470 are examples of a machine-event generating process. The screen shown in FIG. 10 when an operation is performed on the printer 100 is an example of a third displaying screen. A process of displaying a screen corresponding to the process in S100 and S300 is an example of a fifth displaying process. Third display screen data is an example of third screen data, and S110 and S310 are examples of a third generating process. S115 and S315 are examples of a fifth transmitting process, and S120 and S320 are examples of a fifth receiving process. S125 and S325 are examples of a sixth transmitting process, and S130 and S330 are examples of a sixth receiving process. A mode in which the ripple animation is displayed in white is an example of a third mode, and a mode in which the ripple animation is displayed in a color other than white that corresponds to the printer 100 is an example of a fourth mode. S135 and S335 are examples of a sixth displaying process.

Image information generated in S425 is an example of fourth screen data, and S425 is an example of a fourth generating process. S430 is an example of a seventh transmitting process and S435 is an example of a seventh receiving process. S440 is an example of a seventh displaying process. The changed image information is an example of fifth screen data, and S480 is an example of a fifth generating process. S485 is an example of an eighth transmitting process, S490 is an example of an eighth receiving process, and S495 is an example of an eighth displaying process.

### Effects of Embodiment

As described above, in the present embodiment of the remote control system 1, the NW terminals 300I, 300E are connected to the printer 100 via the servers 200I, 200E. As the processor 110 of the printer 100 transmits the image information generated in S35 and S235 to the NW terminals 300I, 300E via the server 200, the screen displayed on the touch panel 140 of the printer 100 in S60, S30, and S230, is displayed on the display 340 in S260.

According to the present embodiment, the screen display on the printer 100 and the screen display on the NW terminals 300I, 300E can be remotely controlled in conjunction with each other via the server 200. The remote control can be performed by accessing the URL of the server 200E from the printer 100 and also from the NW terminal 300E to the URL of the server 200E, in particular to the wide-area network GAN. As a result, the user does not have to go through a complicated process such as when the printer is controlled remotely from a local terminal directly connected to the printer 100, thereby improving convenience. As a result, users can remotely control the printer 100 from the NW terminals 300I, 300E without complicated processes.

Further, in the present embodiment, when the display of the touch panel 140 changes to the changed screen in S100, the changed image information generated by the processor 110 of the printer 100 is transmitted to the NW terminals 300I, 300E via the server 200 and is displayed in S135 and S335 on the display 340 in S135 and S335. According to the present embodiment, the changed image information is transmitted to the NW terminals 300I, 300E via the server 200 only when the display on the touch panel 140 changes. Therefore, the communication load from the printer 100 to the server 200 and the processing load on the server 200 can be reduced.

In the present embodiment, by performing an input operation on a particular position on the screen displayed on the display 340 of the NW terminals 300I, 300E, the corresponding operation information is transmitted to the printer 100 via the server 200, thereby causing a corresponding change to the screen, and the screen can be switched to a changed screen. According to the present embodiment, operations on the NW terminals 300I, 300E can be smoothly transmitted to the printer 100 for reliable remote control.

In the present embodiment, when the screen is switched to the changed screen, it is identified in S105 and S305 whether the change is based on operation information in response to the operation of the NW terminals 300I, 300E, or whether it is a change over time in, for example, the time display or the consumable status of consumables that is unrelated to the above operation. Then, the changed image information is generated and transmitted to the server 200 only based on the operation of the NW terminals 300I, 300E, and if it is not based on the operation of the NW terminals 300I, 300E, the changed screen information is not transmitted to the server 200. According to the present embodiment, the communication load from the printer 100 to the server 200 and the processing load on the server 200 are reduced, and the remote control process can be performed smoothly.

In the present embodiment, new input operations to the display 340 are disabled until the corresponding changed screen is displayed after an input operation is performed on the screen at the NW terminals 300I, 300E. According to the present embodiment, a server load is reduced as continuous communication from the NW terminals 300I, 300E to the server 200 is prevented.

Similarly, after an input operation is performed on the screen at the NW terminal 300I, 300E, the operation information corresponding to the new input operation on the display 340 is not transmitted to the printer 100 until the corresponding changed screen is displayed. According to the present embodiment, the communication load is reduced as continuous communication from the server 200 to the printer 100 is prevented. It is noted that the process of disabling the receiving of operation information between S95 and S135 at which the changed screen is displayed is an example of a disabling process.

Although not specifically illustrated, multiple NW terminals 300E may simultaneously and remotely control the same printer 100 via the server 200E in the wide-area network GAN. For example, it is assumed that both a first NW terminal 300Ea and a second NW terminal 300Eb are configured to remotely control the printer 100 via the server 200E. When the first NW terminal 300Ea of those two remotely controls the printer 100 and the screen is switched to the changed screen, the display 340 of the first NW terminal 300Ea displays a white ripple animation 342 corresponding to its own terminal on the changed screen. In such a case, the display 340 of the second NW terminal 300Eb is also switched from the screen to the changed screen in conjunction with the operation on the first NW terminal 300Ea. In such a case, the display 340 of the second NW terminal 300Eb may show a ripple animation 343 with a different color (e.g., yellow) corresponding to the other terminal, other than the white color for the changed screen described above.

According to this configuration, it is easy for users to visually understand whether the image display has been updated by the remote control of their own terminal or by the remote control of another terminal at each of the multiple NW terminals 300E. It should be noted that the above may be applied to the case where multiple LC terminals 300L remotely control the same printer 100 simultaneously in a premises network LAN. The above example of displaying the ripple animation in white for the user's terminal is an example of a first mode, and displaying the ripple animation in a color other than white for the other terminal is an example of a second mode.

The display of the white ripple animation 342 corresponding to the above operation of the own terminal is a limited display in a particular period of time until the display expands and disappears. It is preferable that the NW terminal 300E of the concerned own terminal does not accept new input operations while displaying the white ripple animation 342. According to such a configuration, useless input from the user for consecutive hits can be ignored and operability can be stabilized.

In the present embodiment, the touch panel 140 of the printer 100 is configured to be directly operable by bringing the user's finger into contact with or in close proximity to the touch panel 140. In a state where a screen is displayed by remote control by the NW terminals 300I, 300E, when the screen is switched to the changed screen by direct operation on the touch panel 140, the changed screen is displayed in place of the screen on the display 340 of the NW terminals 300I, 300E in conjunction with the change. In that case, the ripple animation 343 is displayed in a different color corresponding to the printer 100 (e.g., green), which is different from the white color corresponding to the own terminal or the colors corresponding to other terminals. In this way, according to the present embodiment, the user can easily and visually understand that the screen display has been updated on the NW terminals 300I, 300E by direct operation of the printer 100 by another user, not by the remote control of the user's terminal.

According to the present embodiment, in the pull-type connection configuration, the printer 100 obtains the operation information from the server 200I using the polling technique. Concretely, the server 200I stores the operation information received in S285 in the storage device 215, and the printer 100 actively queries the server 200I at particular time intervals, for example, every 5 seconds, to check whether the operation information is available. Then, when the server 200I stores the operation information in response to that query, transmission and reception of the operation information is performed in S290 and S295 above. In this way, communication between the printer 100 and the server 200 can be performed with a minimum required communication load.

In the local type connection configuration, since information can be transmitted and received with large capacity and low delay, there is no problem in transmitting and receiving image information by polling with a cycle based on the machine cycle of the printer 100 or a relatively short time interval, such as every 5 seconds, for example. In such a case, the operation information corresponding to the operation on the LC terminal 300L is stored in the memory 320 of the LC terminal 300L. The printer 100 queries the server 200I at its machine cycle or at a particular time interval cycle to check whether the operation information is available, and at the time of the query, the operation information from the LC terminal 300L is obtained by the printer 100. In this way, the communication between the printer 100 and the LC terminal 300L can be performed with the minimum communication load since the printer 100 can obtain the operation information from the LC terminal 300L by the polling technique. In such a case, S450 is an example of a second operation receiving process, and the process of storing the operation information in the memory 320 in S450 is an example of a second event storing process. The machine cycle or particular time interval of the printer 100 is a second particular period. A process in which the printer 100 actively queries the LC terminal 300L for the presence or absence of operation information at machine cycles or at particular time intervals before S460 is an example of a second event query transmitting process. A process that transmits operation information to the printer 100 in response to the query process is an example of a third event transmitting process.

When the remote control is performed from the LC terminal 300L, the updating process of the image display is performed based on the polling process, while when the remote control is performed from the NW terminals 300I and 300E, the updating process of the image display can be performed not based on the polling process.

### Modifications

While aspects of the present disclosure have been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of aspects of the present disclosure, and not limiting the same. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

### (1) Exclusive Performance of Remote Control Between Different Connection Configurations

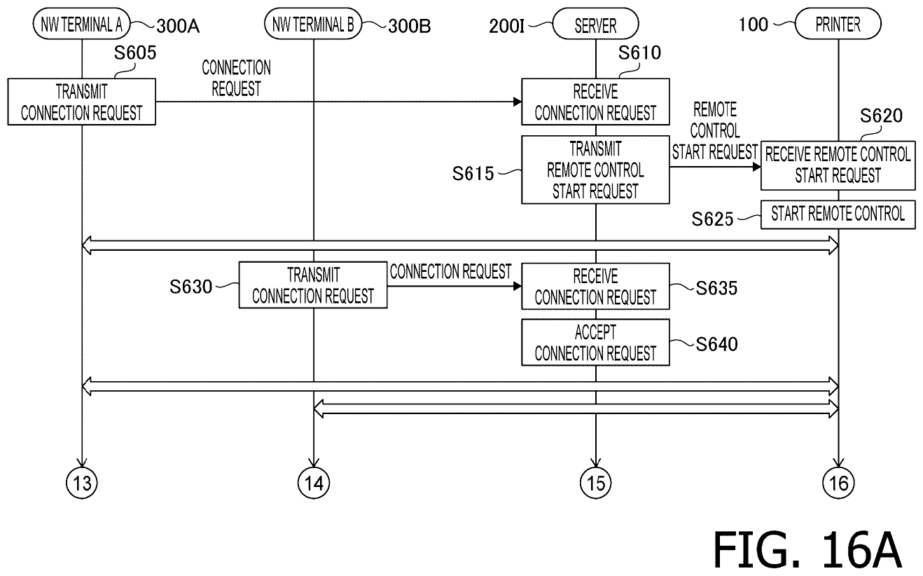

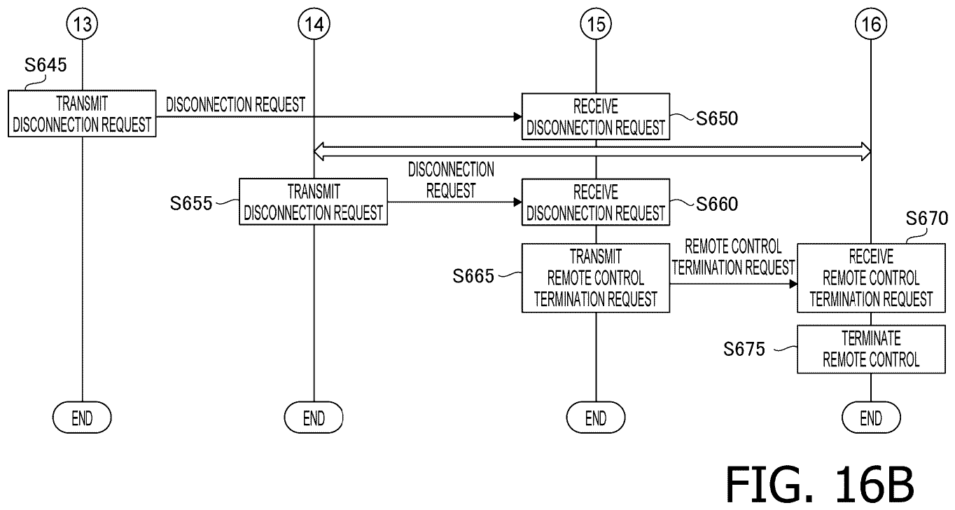

In the above embodiment, only the case where the single terminal 300 remotely controls a printer 100 was described. However, as shown in FIGS. 16A and 16B, for example, multiple terminal devices 300 in the same connection configuration may simultaneously remotely control the same printer 100.

In the example shown in the figure, there are NW terminals 300A and 300B, both of which have a pull-type connection configuration through the same server 200I. First, the NW terminal 300A transmits a connection request in S605, the server 200I receives the request in S610, and then transmits a remote control start request to the printer 100 in S615. The printer 100 receives the remote start request at step S620 and starts remote control normally at step S625.

Then, when the NW terminal 300A is in a remote control state and another NW terminal 300B transmits a connection request to the same server 200I in S630, the server 200I that receives the connection request in S635 will accept the connection request in S640. In other words, in S640, the connection with the printer 100 is established through the same process as in S615-S625 above, and the remote control is enabled (not shown).

Thereafter, the NW terminals 300A and 300B, which are both in the pull-type connection configuration via the same server 200I, can remotely control the printer 100 concurrently. Then, in the example shown in the figure, the NW terminal 300A first transmits a disconnection request in S645, and the server 200I receives this request in S650 and terminates the remote control of the NW terminal 300A. Thereafter, the NW terminal 300B transmits a disconnection request in S655, and the server 200I receives the disconnection request in S660, and transmits a remote control termination request to the printer 100 in S665. The printer 100 receives the remote control termination request at S670 and terminates the remote control normally at S675.

As described above, multiple terminal devices 300 in the same connection configuration can remotely control the same printer 100 simultaneously. Although not specifically shown in the figure, multiple terminal devices 300 in a push-type connection configuration via the same server 200E or multiple terminal devices 300 in the same local connection configuration may be configured to remotely control the same printer 100 simultaneously.

However, there is a possibility that users of multiple terminal devices 300 each connected to the same printer 100 in different connection configurations have a relationship in which they have little need to share information with each other, for example, they belong to different departments or organizations. Therefore, from the viewpoint of preventing information leakage, it is desirable to perform exclusive connection processing so that multiple terminal devices 300 with different connection configurations cannot remotely control the same printer 100 at the same time. Therefore, when multiple terminal devices 300 with different connection configurations connect to the printer 100 at different times without overlap, the remote control is allowed, but if one terminal 300 is connecting first and then another terminal 300 with a different connection configuration submits a connection request, the remote control is not allowed so that the other terminal 300 is not allowed to connect to the printer 100.

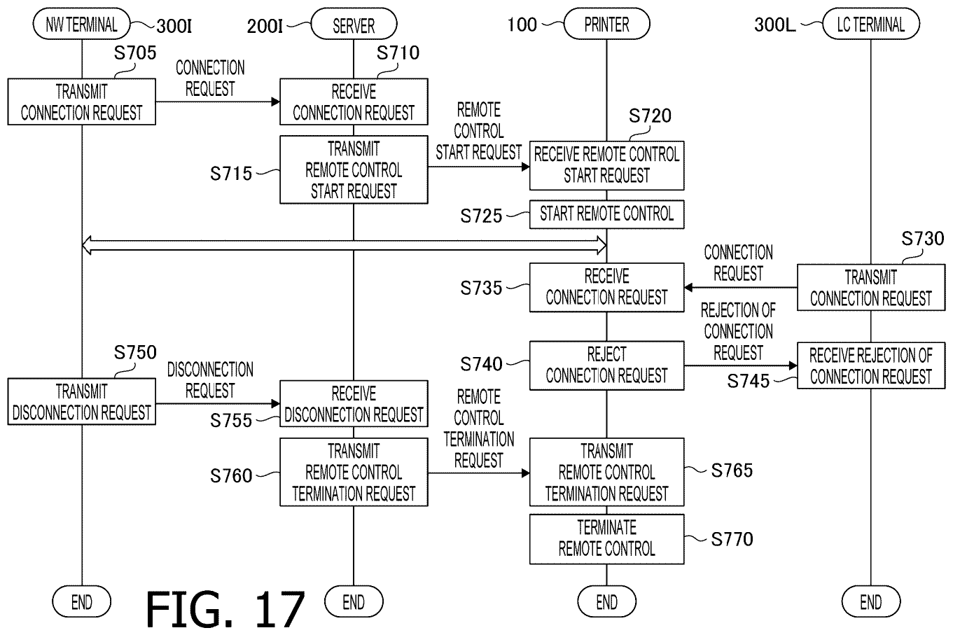

For example, as shown in FIG. 17, the NW terminal 300 in pull-type connection configuration first transmits a connection request at S705, and then the server 200I receives the connection request at S710 and transmits a remote control start request at S715. If the printer 100 receives the connection request at S720, the printer 100 starts remote control normally at S725.

If the LC terminal 300L in the local connection configuration transmits a connection request to the printer 100 in S730 while this remote control is in progress, the printer 100, which receives the connection request in S735, replies to reject the connection request in S740. The LC terminal 300L that receives this rejection of connection request in S745 cannot connect to the printer 100.

The above exclusive execution process is similarly rejected if the NW terminal 300I in the pull-type connection configuration transmits a connection request while the LC terminal 300L in the local connection configuration is connecting first, in the reverse order. Further, the same applies when the pull-type connection configuration is substituted for the push-type connection configuration (not shown).

In other words, the processor 110 of the printer 100 exclusively performs one of the following two processing modes: a first mode-related processing mode including generating, transmitting, and display processes of image information and changed image information according to a first mode associated with the NW terminals 300I, 300E; and a second mode-related processing mode including generating, transmitting, and display processes of image information and changed image information according to a second mode associated with the LC terminal 300L.

As described above, in this modification, the first mode-related processing mode when remotely controlling the printer 100 from the NW terminals 300I, 300E via the server 200 and the second mode-related processing mode when remotely controlling the printer 100 from the LC terminal 300L are performed independent of each other. In this way, it is prevented that the printer 100 is remotely controlled from the LC terminal 300L when the user is remotely controlling the printer 100 from the NW terminals 300I, 300E, and it is prevented that the printer 100 is remotely controlled from the NW terminals 300I, 300E when the user is remotely controlling the printer 100 from the LC terminal 300L. According to this modification, information security and smoothness of control processing can be ensured by not mixing the remote control through the server 200 and the remote control without the server 200.

Although not specifically illustrated, multiple users with different connection configurations may be allowed to remotely control the same printer 100 at the same time, provided that the process of obtaining consent between the users is possible via a separate application program. Further, if, for example, a user who directly operates the printer 100 and a call center operator who is a user of the NW terminal 300E in the wide-area network GAN can simultaneously operate the same printer 100, they can check each other's operation of the printer 100. This improves the efficiency and quality of customer service.

### (2) Determination of Long-Press Operation

When a user performs an important operation such as a system reset, the user may be required to press and hold the device continuously for a particular period of time or longer, unlike other normal press operations. In order to reliably determine whether such a long press operation has been performed or not, it is necessary to detect the timing of each press input operation and release input operation performed consecutively for the same operation key precisely. However, in the NW terminal 300E that exists in the wide-area network GAN, traffic delays are likely to occur, and from the server 200E, there are likely to be gaps in timings for detecting each of the press input operation and release input operation at the NW terminal 300E. Therefore, it is difficult to perform accurate long-press determination in such an NW terminal 300E.

The process for determining the long-press operation is to calculate a time interval between the detection timing of each of the press input operation and the release input operation, and determine whether the time interval is greater than or equal to a particular threshold value. However, in many cases, the threshold is set and stored by the printer 100. Accordingly, at least the NW terminal 300E needs to detect the respective timing of the press input operation and the release input operation, but the final determination of the comparison of the time interval and the threshold value should be made by the printer 100, and the calculation process of the time interval until then should be done by any one of the NW terminal 300E, the server 200E, or the printer 100.

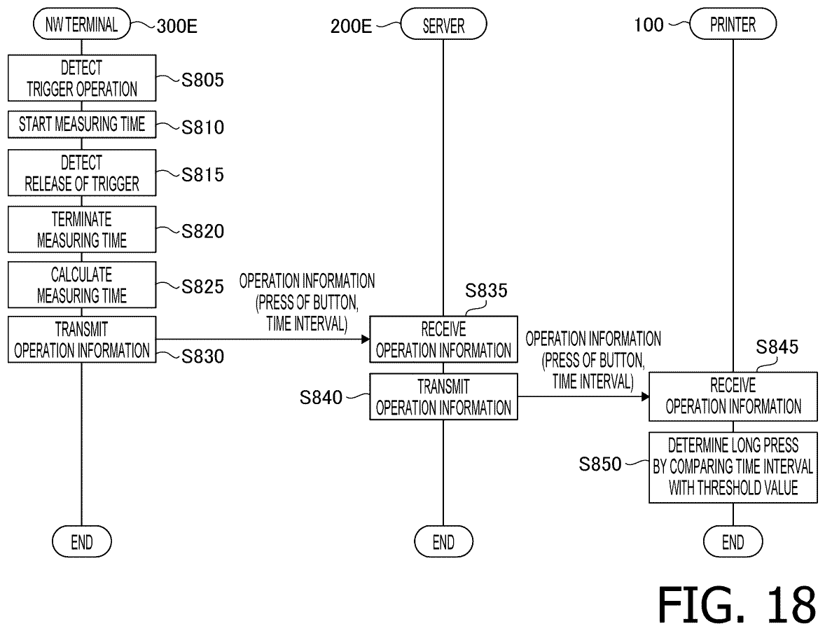

FIG. 18 shows a sequence chart showing a case in which the NW terminal 300E performs even the process of calculating the time interval. As shown in the figure, when the NW terminal 300E detects a trigger operation of a specific operation key pressed by the user in S805, the NW terminal 300E immediately starts measuring time using a timer built in the CPU 310 in S810. When the release input operation is subsequently trigger-detected in S815, the measurement of the timer is immediately terminated in S820. The time measured by the timer corresponds to the time interval between the press input operation and the release input operation, and this time is calculated by converting the same to a normal time unit in S825, and then transmitted to the server 200E in S830. After receiving the time interval information in S835, the server 200E transmits the time interval information to the printer 100 in S840. After receiving the time interval information in S845, the printer 100 determines whether a long press operation has been performed by comparing the time interval with a threshold value in S850.

It is noted that the detection timing of the press input operation is an example of press input operation time information, and the detection timing of the release input operation is an example of release input operation time information. Special processing such as resetting is an example of a first particular process and a third particular process. Processing in a case of a normal short press operation is an example of a second particular process and a fourth particular process.

As described above, according to the present modification, the time interval during which the NW terminal 300E in the wide-area network GAN is continuously pressed can be accurately measured, and the printer 100 can perform accurate long-press determining processing by comparing the threshold value set and stored in the printer 100 with the measured time interval.

Although not specifically shown in the figure, the server 200 may be configured to determine whether a specific operation key is pressed and held down by the user's finger being in contact with or in close proximity to the touch panel 140 of the printer 100. In such a case, it is preferable that the server 200 stores the threshold values. In such a case, the user's finger is an example of an indicator, and the process by which the server 200 compares the time interval with the threshold value to make a determination is an example of a first long-press determining process. In this way, the determining process can be performed when the touch panel 140 of the printer 100 is directly pressed and held down.

The sequence diagrams shown in FIG. 11A through FIG. 18 are not intended to limit aspects of the present disclosure to the procedures shown in the above sequences, and procedures may be added, deleted, or the order of procedures may be changed so long as the purpose and technical concept of the invention are not departing from aspects of the present disclosure.

Further, in addition to what has already been described above, the methods according to the above embodiments and each of the modifications may be used in combination as appropriate.

Furthermore, although not shown in every example, the present invention may be implemented with various modifications within the scope of not departing from the intent of aspects of the present disclosure.

What is claimed is:

1. A remote control system comprising an image processing apparatus, a server, and at least one network terminal, the image processing apparatus including an image processing controller and an image processing display, the server including a server controller, the network terminal including a network terminal controller and a network terminal display, a remote control of the image processing apparatus by user operations on the network terminal through the server being enabled,
wherein the image processing controller is configured to perform:
a first displaying process of displaying a first display screen on the image processing display;
a first generating process of generating first screen data that indicates the first display screen, the first screen data enabling the network terminal display to display the first display screen; and
a first transmitting process of transmitting the first screen data generated in the first generating process to the server,
wherein the server controller is configured to perform:
a first receiving process of receiving the first screen data transmitted from the image processing controller in the first transmitting process; and
a second transmitting process of transmitting the first screen data received in the first receiving process to the network terminal, and
wherein the network terminal controller is configured to perform:
a second receiving process of receiving the first screen data transmitted from the server controller in the second transmitting process; and
a second displaying process of displaying the first display screen on the network terminal display based on the first screen data received in the second receiving process.

2. The remote control system according to claim 1,
wherein the image processing controller is configured to perform:
a third displaying process of displaying a second display screen, instead of the first display screen, on the image processing display, the second display screen being a screen changed from the first display screen;
a second generating process of:
generating second screen data that indicates the second display screen when the second display screen is displayed on the image processing display in the third displaying process, the second screen data enabling the network terminal display to display the second display screen; and
a third transmitting process of transmitting the second screen data generated in the second generating process to the server,
wherein the server controller is configured to perform:
a third receiving process of receiving the second screen data transmitted from the image processing controller in the first transmitting process; and
a fourth transmitting process of transmitting the second screen data received in the third receiving process to the network terminal, and
wherein the network terminal controller is configured to perform:
a fourth receiving process of receiving the second screen data transmitted from the server controller in the fourth transmitting process; and
a fourth displaying process of displaying the second display screen instead of the first display screen displayed on the network terminal display based on the second screen data received in the fourth receiving process.

3. The remote control system according to claim 2,
wherein the network terminal controller is configured to perform:
a first operation receiving process of receiving an input operation to a particular position on the first display screen displayed on the network terminal in the second displaying process; and
a first event transmitting process of transmitting touch event information corresponding to the input operation received in the first operation receiving process, wherein the server controller is configured to perform:
a first event receiving process of receiving the touch event information transmitted from the network terminal controller in the first event transmitting process; and
a second event transmitting process of transmitting the touch event information received in the first event receiving process to the image processing apparatus, and
wherein the image processing controller is configured to:
perform a second event receiving process of receiving the touch event information transmitted from the server controller in the second event transmitting process; and
in the third displaying process, display the second display screen, which is changed from the first display screen, on the image processing display in response to the touch event information received in the second event receiving process.

4. The remote control system according to claim 3,
wherein the image processing controller is configured to:
perform a change identifying process of identifying whether the second display screen is the second display screen changed from the first display screen in response to the touch event information or the second display screen is the second display screen changed from the first display screen in response to information other than the touch event information;
when, in the change identifying process, the second display screen is the second display screen changed from the first display screen in response to the touch event information, generate the second screen data in the second generating process and transmit the generated second screen data to the server in the third transmitting process; and
when, in the change identifying process, the second display screen is the second display screen changed from the first display screen in response to the information other than the touch event information, not perform the second generating process and the third transmitting process.

5. The remote control system according to claim 4,
wherein the image processing display of the image processing apparatus is a touch screen panel,
wherein the image processing apparatus further comprises a plurality of operation keys configured to receive a pressing operation,
wherein each of the first display screen and the second display screen includes a liquid crystal display screen of the touch screen panel and icons of the plurality of keys, and
wherein the touch event information includes at least one of coordinate position information of the pressing operation on the liquid crystal display screen or pressed key information indicating which icon of the plurality of keys is operated by the pressing operation.

6. The remote control system according to claim 5,
wherein the image processing controller is configured to:
perform a machine-operation receiving process of receiving an input operation to the touch screen panel or the plurality of keys;
perform a machine-event generating process of generating the touch event information corresponding to the input operation received in the machine-operation receiving process; and
in the third displaying process, display the second display screen changed from the first display screen on the image processing display in response to the touch event information generated in the machine-event generating process.

7. The remote control system according to claim 3,
wherein the server further comprises a server storage,
wherein the server controller is configured to perform:
a first event storing process of storing, in the server storage, the touch event information received in the first event receiving process,
wherein the image processing controller is configured to perform:
a first event query transmitting process of transmitting a query to the server at first particular intervals to check for the existence of the touch event information stored in the server storage, and
wherein the server controller is configured to transmit, in the second event transmitting process, the touch event information stored in the server storage to the image processing apparatus when receiving the query from the image processing controller in the first event query transmitting process.

8. The remote control system according to claim 3,
wherein the image processing display of the image processing apparatus is a touch screen panel,
wherein the input operation received in the first operation receiving process includes:
a press input operation corresponding to contact of an indicator with the touch screen panel or close proximity of the indicator to the touch screen panel; and
a release input operation corresponding to release of the indicator from contact with or close proximity to the touch screen panel,
wherein the touch event information includes:
press event information, which corresponds to the press input operation, including press input operation time information; and
release event information, which corresponds to the release input operation, including release input operation time information, and
wherein the server controller is configured to:
perform a first long-press determining process of determining whether a time interval is longer than a particular threshold value based on the press event information and the release event information included in the touch event information received in the first event receiving process, the time interval being an interval between the press input operation time information of the press event information and the release input operation time information of the release event information; and
in response to determining whether the time interval is longer than the particular threshold value, transmit touch event information to the image processing apparatus in the second event transmitting process, the touch event information causing the image processing apparatus to perform a first particular process or a second particular process different from the first particular process.

9. The remote control system according to claim 3,
wherein the image processing display of the image processing apparatus is a touch screen panel,
wherein the input operation received in the first operation receiving process includes:
a press input operation corresponding to contact an indicator with the touch screen panel or close proximity of the indicator to the touch screen panel; and
a release input operation corresponding to release of the indicator from contact with or close proximity to the touch screen panel,
wherein the touch event information includes:
press event information, which corresponds to the press input operation, including press input operation time information; and
release event information, which corresponds to the release input operation, including release input operation time information, and
wherein the image processing controller is configured to:
perform a second long-press determining process of determining whether a time interval is longer than a particular threshold value based on the press event information and the release event information included in the touch event information received in the second event receiving process, the time interval being an interval between the press input operation time information of the press event information and the release input operation time information of the release event information; and
in response to determining whether the time interval is longer than the particular threshold value, perform a third particular process or fourth particular process different from the third particular process.

10. The remote control system according to claim 3,
wherein the network terminal controller is configured to perform a disabling process of disabling a new input operation to the network terminal display until the second display screen is displayed on the network terminal display when the second display screen in displayed on the network terminal display instead of the first display screen in the fourth displaying process based on the input operation received in the first operation receiving process.

11. The remote control system according to claim 3,
wherein the image processing controller is configured to perform a disabling process of disabling receiving of new touch event information corresponding to a new input operation to the network terminal display until the second display screen is displayed on the image processing display when the second display screen in displayed on the image processing display instead of the first display screen in the third displaying process based on the touch event information, which is received in the second event receiving process, corresponding to the input operation to the network terminal.

12. The remote control system according to claim 3, further comprising a plurality of network terminals including a first network terminal and a second network terminal, remote control of the image processing apparatus being enabled by a user operation to each of the first network terminal and the second network terminal,
wherein the image processing controller is configured to:
in the first generating process, generate the first screen data enabling the network terminal display of each of the first network terminal and the second network terminal to display the first display screen; and
in the first transmitting process, transmit the first screen data generated in the first generating process to the server,
wherein the server controller is configured to:
in the first receiving process, receive the first screen data transmitted from the image processing controller in the first transmitting process; and
in the second transmitting process, transmit the first screen data to each of the first network terminal and the second network terminal,
wherein the network terminal controller of each of the first network terminal and the second network terminal is configured to:
in the second receiving process, receive the first screen data transmitted from the server controller in the second transmitting process; and
in the second displaying process, display the first display screen on the network terminal display of each of the first network terminal and the second network terminal,
wherein the network terminal controller of the first network terminal is configured to:
in the first operation receiving process, receive an input operation to a particular position on the first display screen displayed on the network terminal of the first network terminal in the second displaying process; and
in the first event transmitting process, transmit touch event information corresponding to the input operation received in the first operation receiving process,
wherein the server controller is configured to:
in the first event receiving process, receive the touch event information transmitted from the network terminal controller of the first network terminal in the first event transmitting process; and
in the second event transmitting process, transmit the touch event information received in the first event receiving process to the image processing apparatus,
wherein the image processing controller is configured to:
in the second event receiving process, receive the touch event information transmitted from the server controller in the second event transmitting process;
in the third displaying process, display the second display screen, which is a screen changed from the first display screen, on the image processing display in response to the touch event information received in the second event receiving process;
in the second generating process, generate the second screen data enabling the network terminal display of each of the first network terminal and the second network terminal to display the second display screen; and
in the third transmitting process, transmit the second screen data generated in the second generating process to the server,
wherein the server controller is configured to:
in the third receiving process, receive the second screen data transmitted from the image processing controller in the third transmitting process; and
in the fourth transmitting process, transmit the second screen data received in the third receiving process to each of the first network terminal and the second network terminal, wherein the network terminal controller of the first network terminal is configured to:
in the fourth receiving process, receive the second screen data transmitted from the server controller in the fourth transmitting process; and
in the fourth displaying process, switch the first display screen displayed on the network terminal display of the first network terminal to the second display screen based on the second screen data received in the fourth receiving process and display the second display screen in a first mode, and
wherein the network terminal controller of the second network terminal is configured to:
in the fourth receiving process, receive the second screen data transmitted from the server controller in the fourth transmitting process; and
in the fourth displaying process, switch the first display screen displayed on the network terminal display of the first network terminal to the second display screen based on the second screen data received in the fourth receiving process and display the second display screen in a second mode different form the first mode.

13. The remote control system according to claim 12,
wherein the network terminal controller of the first network terminal is configured to, in the fourth displaying process, display the second display screen in the first mode only in a particular period and not to perform the first operation receiving process in the particular period.

14. The remote control system according to claim 2,
wherein the image processing display of the image processing apparatus is a touch screen panel;
wherein the image processing controller is configured to perform:
an instruction receiving process of receiving an instruction operation by an indicator contacting, coming into proximity to, or releasing from the touch screen panel;
a fifth displaying process of displaying a third display screen, instead of the first display screen, on the image processing display, the third display screen being a screen changed from the first display screen based on the instruction operation received in the fifth displaying process;
a third generating process of:
generating third screen data that indicates the third display screen when the third display screen is displayed on the image processing display in the fifth displaying process, the third screen data enabling the network terminal display to display the third display screen; and
a fifth transmitting process of transmitting the third screen data generated in the third generating process to the server,
wherein the server controller is configured to:
a fifth receiving process of receiving the third screen data transmitted from the image processing controller in the fifth transmitting process; and
a sixth transmitting process of transmitting the third screen data received in the fifth receiving process to the network terminal, and
wherein the network terminal controller is configured to perform:
a sixth receiving process of receiving the third screen data transmitted from the server controller in the sixth transmitting process; and
a sixth displaying process of displaying the third display screen, instead of the first display screen displayed on the network display in a third mode, in a fourth mode different from the third mode, based on the third screen data received in the sixth receiving process.

15. The remote control system according to claim 2, further comprising a local terminal including a local terminal controller and a local terminal display, remote control of the image processing apparatus being enabled by a user operation to the local terminal,
wherein the image processing controller is configured to perform:
a fourth generating process of generating fourth screen data enabling the local terminal display to display the first display screen, the fourth screen data indicating the first display screen displayed in the first displaying process; and
a seventh transmitting process of transmitting the fourth screen data generated in the fourth generating process to the local terminal,
wherein the local terminal controller of the local terminal is configured to perform:
a seventh receiving process of receiving the fourth screen data transmitted from the image processing controller in the seventh transmitting process; and
a seventh displaying process of displaying the first display screen on the local terminal display based on the fourth screen data received in the seventh receiving process,
wherein the image processing controller is configured to perform:
a fifth generating process of:
generating fifth screen data that indicates the second display screen when the second display screen is displayed in the seventh displaying process instead of the first display screen, the fifth screen data enabling the local terminal display to display the second display screen; and
an eighth transmitting process of transmitting the fifth screen data generated in the fifth generating process to the local terminal,
wherein the local terminal controller is configured to perform:
an eighth receiving process of receiving the fifth screen data transmitted from the image processing controller in the eighth transmitting process; and
an eighth displaying process of displaying the second display screen instead of the first display screen displayed on the local terminal display based on the fifth screen data received in the eighth receiving process, and
wherein the image processing controller is configured to exclusively perform one of:
a first mode-related processing mode including the first generating process, the first transmitting process, the third displaying process, the second generating process, and the third transmitting process according to a first mode associated with the network terminal connected to the image processing apparatus through the server; and
a second mode-related processing mode including the fourth generating process, the seventh transmitting process, the fifth generating process, and the eighth transmitting process according to a second mode associated with the local terminal, the second mode being performed independently of the first mode.

16. The remote control system according to claim 15,
wherein the local terminal further includes a local storage,
wherein the local terminal controller is configured to perform:
a second operation receiving process of receiving an input operation to a particular position on the first display screen displayed on the local terminal in the seventh displaying process; and
a second event storing process of storing, in the local storage, touch event information corresponding to the input operation received in the second operation receiving process,
wherein the image processing controller is configured to perform a second event query transmitting process of transmitting a query to the server at second particular intervals to check for the existence of the touch event information to be stored in the terminal storage, and
wherein the local terminal controller is configured to perform a third event transmitting process of transmitting, to the image processing apparatus, touch event information stored in the terminal storage in the second event storing process when receiving the query from the image processing controller in the second event query transmitting process.

17. An image processing apparatus, comprising an image processing controller, and an image processing display, a remote control of the image processing apparatus by user operations on a network terminal through a server being enabled,
wherein the image processing controller is configured to perform:
displaying a first display screen on the image processing display;
generating first screen data that indicates the first display screen, the first screen data enabling the network terminal display to display the first display screen;
transmitting the first screen data to the server and displaying the first display screen on the network terminal based on the first screen data received from the server;
displaying a second display screen instead of the first display screen on the image processing display, the second display screen being a screen changed from the first display screen;
generating second screen data that indicates the second display screen when the second display screen is displayed on the image processing display, the second screen data enabling the network terminal display to display the second display screen; and transmitting the second screen data to the server and displaying the first display screen on the network terminal based on the first screen data received from the server.

18. A non-transitory computer-readable recording medium containing computer-executable instructions to be executed by a controller of a terminal, the computer-executable instructions including a remote control program, the terminal including a terminal display and an arithmetic unit, the terminal being configured to perform remote control of an image processing apparatus by a user operation through the server, the remote control program causing, when executed by the controller, the arithmetic unit to perform operations comprising:
receiving first screen data indicating a first display screen displayed on an image processing display of the image processing apparatus from the server, the first screen data enabling the terminal display to display the first display screen;
displaying the first display screen on the terminal display based on the first screen data;
receiving, from the server, second screen data enabling the terminal display to display a second display screen displayed on the image processing display of the image processing apparatus instead of the first display screen, the second screen data indicating the second display screen changed from the first display screen; and
displaying the first display screen on the terminal display instead of the second display screen based on the second screen data.
